(19) United States
(12) Patent Application Publication
(10) Pub. No.: US 2026/0305591 A1
(43) Pub. Date: Oct. 8, 2026

(54) ICE FISHING ELECTRONICS INTEGRATION ASSEMBLY

(71) Applicant: Wild Wing Woodworks LLC DBA Wild Wing Products, Inver Grove Heights, MN (US)

(72) Inventor: Charles W. Berry, Inver Grove Heights, MN (US)

(21) Appl. No.: 19/463,788

(22) Filed: Jan. 29, 2026

Related U.S. Application Data
(60) Provisional application No. 63/750,862, filed on Jan. 29, 2025.
(60) Provisional application No. 63/824,453, filed on Jun. 16, 2025.

(51) Int. Cl. A01K 97/01; A01K 97/12; F16B 2/10; G01S 15/96

(52) U.S. Cl. CPC A01K 97/01; A01K 97/125; F16B 2/10; G01S 15/96

(57) ABSTRACT

An ice fishing electronics integration assembly couples an electronic shuttle to a transducer mounting rod. The assembly includes a base configured to couple to the electronic shuttle and a first clamp operably coupled to the base. A second clamp is positioned parallel to and spaced apart from the first clamp with axes of rotation being generally parallel. A handle enables transport with the transducer mounting rod in parallel alignment. In some embodiments, a second integration assembly couples to the base via a swivel connection assembly enabling pivoting between a first locked position with the transducer mounting rod oriented vertically and a second locked position with the transducer mounting rod oriented horizontally. The swivel connection includes a keyed coupling mechanism with spring-loaded detents providing tactile feedback at the locked positions.

### CROSS-REFERENCE TO RELATED APPLICATIONS

This application claims priority to U.S. Provisional Application No. 63/750,862, filed Jan. 29, 2025, and U.S. Provisional Application No. 63/824,453, filed Jun. 16, 2025, the entire contents of both of which are incorporated herein by reference.

### TECHNICAL FIELD

The present disclosure relates generally to ice fishing equipment, and more specifically to integration assemblies configured to couple an electronic shuttle and a transducer mounting rod, facilitating stable deployment during use and efficient transport in various configurations.

### BACKGROUND

Ice fishing enthusiasts often utilize forward-facing sonar systems to enhance their fishing experience by providing real-time underwater imaging. These systems typically include a transducer mounted on a pole, an electronic shuttle that houses a power source, display and control interface, and an umbilical cord connecting the transducer to the electronic shuttle. While effective for providing detailed imaging, the current configurations of these systems present challenges in terms of transport, setup, and stability. Transporting the transducer, pole, and electronic shuttle typically requires handling multiple components simultaneously, which can be cumbersome and inefficient, particularly when transitioning between fishing locations. Furthermore, the lack of integrated support systems for these components during transport increases the likelihood of tangling, damage, or misalignment.

In addition to transport challenges, existing configurations often fail to provide optimal stability and usability in the deployed state. The transducer pole must be manually positioned and secured in a vertical orientation over the ice hole, often requiring additional tools or accessories to maintain alignment and depth. This process is further complicated by the variety of electronic shuttles and transducer mounting systems available on the market, each with its own unique design and attachment mechanisms.

### SUMMARY

The present disclosure pertains to an integration assembly designed for use with ice fishing electronics, particularly forward-facing sonar systems. The disclosed assembly facilitates streamlined transport and stable deployment of components, including a transducer, a transducer mounting rod, and an electronic shuttle. The assembly allows these components to be carried as a single, compact unit, mitigating common issues associated with transporting and organizing multiple separate parts. Additionally, the assembly provides a stable and user-friendly platform for operation on ice, addressing challenges related to component stability and compatibility across various electronic shuttle systems.

In one embodiment, the integration assembly includes a base configured to support the sonar system components on a surface in an in-use configuration. The base is further configured to couple to an electronic shuttle. The assembly incorporates turret-style clamps spaced apart in a parallel arrangement, enabling secure retention of a transducer mounting rod while permitting easy attachment and detachment. The assembly also includes a handle designed to facilitate transport by allowing the base to transition to a transport configuration, wherein the base is oriented substantially orthogonal to the supporting surface, and the handle aligns parallel to the transducer mounting rod. This configuration enhances portability and reduces the effort required for transitioning between fishing locations.

In some embodiments, the base comprises a mounting interface configured to accommodate attachment to electronic shuttles from different manufacturers. The base or the structure spaced above it can be constructed from high-density polyethylene for durability and lightweight portability. The handle may be constructed from a flexible material, such as nylon webbing, a thermoplastic elastomer, or a rubberized polymer, and can include ergonomic features such as finger grips or textured surfaces for enhanced usability. The handle may also be detachably coupled to the assembly, allowing repositioning to an opposing side according to user preference, and in one embodiment, the handle's grasping portion can form an angle of less than 20 degrees with the first axis for ergonomic transport.

Additional features of the assembly include tool holders integrally formed with or attached to the base or the structure spaced above the base, providing convenient storage for ice fishing tools such as pliers or line cutters. Adjustable rod holders may also be operably coupled to the assembly for secure retention of fishing rods during use or transport. A lure charger with a light-emitting component can be operably coupled to the base or the structure above it, enabling luminescent fishing lures to be conveniently charged, and may include a dedicated power switch and a connector interfacing with a power accessory port of the electronic shuttle.

To provide enhanced stability in the transport configuration, the base may include one or more feet positioned opposite the handle, ensuring the assembly remains upright when set down. Furthermore, a shoulder strap can be operably coupled to the assembly to facilitate hands-free transport.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated herein and form a part of this disclosure, illustrate various embodiments and aspects of the present disclosure. The drawings are briefly described as follows:

FIG. 1 is a perspective view illustrating an integration assembly operably coupling an electronic shuttle to a transducer mounting rod in the in-use configuration, in accordance with an embodiment of the disclosure.

FIG. 2 is an alternative perspective view of the integration assembly of FIG. 1.

FIG. 3 is a close-up perspective view depicting the connection between the integration assembly, the electronic shuttle, and the transducer mounting rod in the in-use configuration, in accordance with an embodiment of the disclosure.

FIG. 4 is an alternative close-up perspective view of the connection shown in FIG. 3.

FIG. 5 is a perspective view illustrating the integration assembly enabling transportation of the electronic shuttle and transducer mounting rod in a transport configuration, in accordance with an embodiment of the disclosure.

FIG. 6 is a close-up perspective view of the integration assembly of FIG. 5.

FIG. 7 is a perspective view of the integration assembly, in accordance with an embodiment of the disclosure.

FIG. 8 is an alternate perspective view of the integration assembly of FIG. 7.

FIG. 9 is a perspective view of an integration assembly, in accordance with another embodiment of the disclosure.

FIG. 10 is a plan view illustrating the assembly of components comprising the integration assembly, in accordance with an embodiment of the disclosure.

FIG. 11 is a close-up plan view of a clamp, in accordance with an embodiment of the disclosure.

FIG. 12 is a close-up plan view of a portion of a snap-fit clasp of the clamp shown in FIG. 11.

FIG. 13 is a perspective view depicting a user securing a transducer mounting rod within a clamp of the integration assembly, in accordance with an embodiment of the disclosure.

FIG. 14 is a profile view illustrating parallel alignment of a first axis along pivots of a first and second clamp with a second axis along the grasping portion of a handle within a first plane.

FIG. 15 is a profile view illustrating angular alignment of the first axis relative to the second axis along a second plane substantially orthogonal to the first plane depicted in FIG. 14.

FIG. 16 is a perspective view of the integration assembly being carried in a transport configuration, with the transducer mounting rod positioned on one or more transducer mounting rod supports.

FIG. 17 is a perspective view of the integration assembly defining a plurality of tool holders and one or more fishing rod holders, in accordance with an embodiment of the disclosure.

FIG. 18 is a perspective view of the integration assembly including a lure charger, in accordance with an embodiment of the disclosure.

FIG. 19 is a profile view of the integration assembly including one or more feet and a shoulder strap, in accordance with an embodiment of the disclosure.

FIG. 20 is an assembly view illustrating the integration of an electronic shuttle from one of a plurality of providers with an integration assembly including a plurality of different-sized clamps and transducer mounting rod supports, in accordance with an embodiment of the disclosure.

FIG. 21 is a schematic view of electronic shuttle components incorporated into the integration assembly to form an electronic shuttle, incorporating a pair of transducer mounting rod clamps and a handle, in accordance with an embodiment of the disclosure.

FIG. 22 is a perspective view of an integration assembly in accordance with another embodiment of the disclosure.

FIG. 23 is an alternate perspective view of the integration assembly of FIG. 22.

FIG. 24 is a perspective view illustrating the integration assembly of FIG. 22 operably coupling an electronic shuttle to a transducer mounting rod in an in-use configuration.

FIG. 25 is a perspective view of an integration assembly in accordance with yet another embodiment of the disclosure.

FIG. 26 is an alternate perspective view of the integration assembly of FIG. 25.

FIG. 27 is a perspective view of a clamp including a first part defining a receptacle configured to receive one of a plurality of different sizing inserts, in accordance with an embodiment of the disclosure.

FIG. 28 is a perspective view of the clamp of FIG. 27, depicting the receptacle without a sizing insert.

FIG. 29 is a perspective view of the clamp of FIG. 28, with a sizing insert positioned within the receptacle.

FIG. 30 is a perspective view of an alternative embodiment of a clamp, illustrating a receptacle configured to receive a sizing insert.

FIG. 31 is a perspective view of the clamp of FIG. 30, with a sizing insert positioned within the receptacle.

FIG. 32 is a perspective view depicting a swivel connection between an integration assembly and a transducer mounting rod, with the integration assembly and transducer mounting rod shown separated to illustrate both the female side and male side of the swivel connection, in accordance with an embodiment of the disclosure.

FIG. 33 is a perspective view depicting the integration assembly and transducer mounting rod of FIG. 32 coupled together via the swivel connection.

FIG. 34 is an exploded view of the female side of the swivel connection, in accordance with an embodiment of the disclosure.

FIG. 35 is a perspective view of the assembled female side of the swivel connection having a triangular-shaped keyed opening, in accordance with an embodiment of the disclosure.

FIG. 36 is a perspective view of a triangular-shaped male coupling plate of the male side of the swivel connection, the male coupling plate being insertable into the keyed opening of the female side, in accordance with an embodiment of the disclosure.

FIG. 37 is a plan view depicting the male coupling plate positioned within a cavity defined by the female side of the swivel connection, with the male coupling plate positioned in a first locked position and the transducer mounting rod oriented vertically relative to the integration assembly, in accordance with an embodiment of the disclosure.

FIG. 38 is a perspective view illustrating the transducer mounting rod positioned vertically relative to the integration assembly in the first locked position.

FIG. 39 is a plan view depicting the male coupling plate positioned in a second locked position, with the transducer mounting rod oriented horizontally relative to the integration assembly, in accordance with an embodiment of the disclosure.

FIG. 40 is a perspective view illustrating the transducer mounting rod positioned horizontally relative to the integration assembly in the second locked position.

FIG. 41 is a top plan view of an alternative male coupling plate for the swivel connection assembly according to an embodiment of the present disclosure.

FIG. 42 is a perspective view of an alternative clamp embodiment with a single plug positioned within a center receptacle of a plurality of plug receptacles.

FIG. 43 is a perspective view of a plug for the clamp of FIG. 42.

FIG. 44 is a perspective view of the clamp of FIG. 42 with two plugs positioned within the plug receptacles.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

Forward-facing sonar systems have become an important tool for ice anglers, offering real-time underwater imaging to enhance the fishing experience. These systems work by emitting sonar waves from a transducer, which are reflected by underwater objects and received back at the transducer, allowing users to visualize fish, structures, and the lakebed. A typical forward-facing sonar system includes several components: an electronic shuttle housing a display and control interface; a transducer mounted on a transducer mounting rod to position it at the desired depth beneath the ice; and an umbilical cord connecting the transducer to the electronic shuttle for power and data transmission. While these systems provide are beneficial to anglers, they present challenges related to the transport and deployment of their multiple components. Transporting the transducer, mounting rod, electronic shuttle, and umbilical cord often requires handling each component separately, leading to inefficiencies and increased potential for damage or misalignment during transitions between locations.

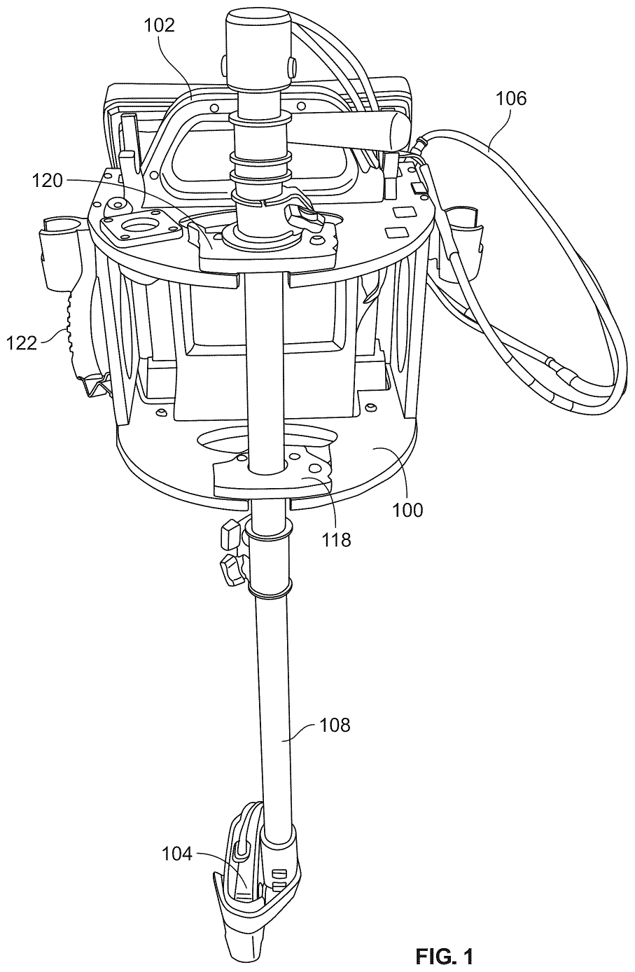

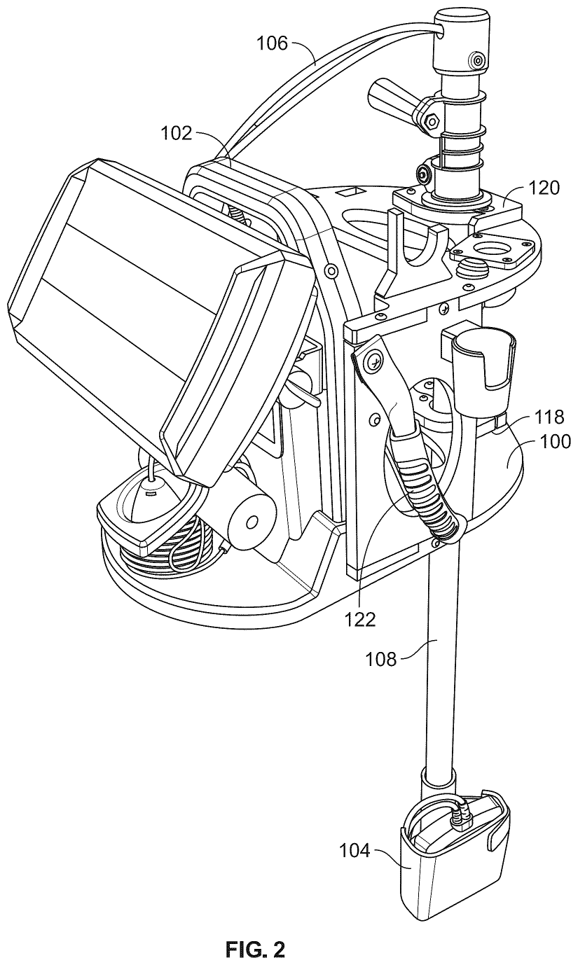

FIGS. 1-2 depict an ice fishing electronics integration assembly 100 in accordance with an embodiment of the disclosure. The integration assembly 100 comprises an electronic shuttle 102, a transducer 104, and a transducer mounting rod 108. The transducer 104 is connected to the electronic shuttle 102 via an umbilical cord 106, which facilitates power and data transmission. The integration assembly 100 provides a unified platform for securing and organizing these components, thereby streamlining their transport and deployment.

In an in-use configuration (as depicted in FIGS. 1-2), the integration assembly 100 positions the transducer mounting rod 108 vertically, allowing the transducer 104 to be located within an ice hole at a desired depth. The base of the integration assembly 100 supports the entire system on the surface of the ice, while clamps securely hold the transducer mounting rod 108 in place. The electronic shuttle 102 as part of the integration assembly 100, provides a stable interface for the display and control mechanisms.

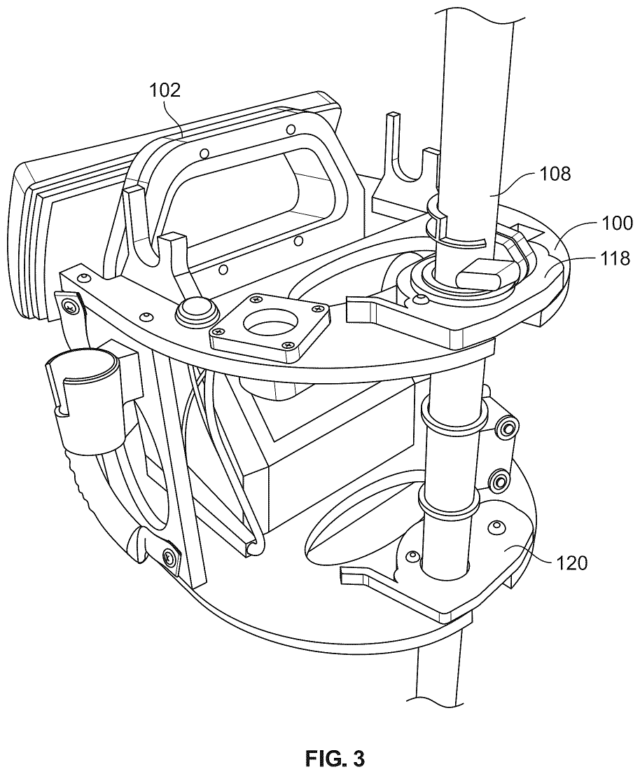

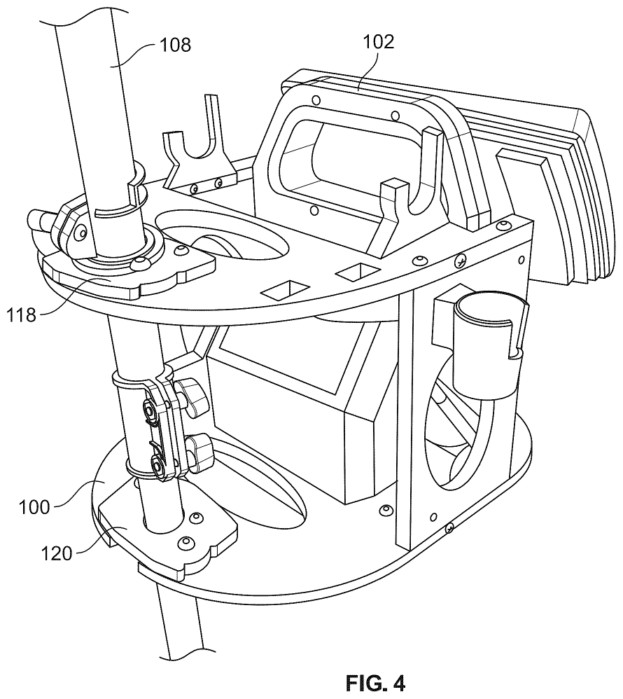

FIGS. 3-4 illustrate close-up views of the integration assembly 100 in the in-use configuration, highlighting details of its structure and functionality. The electronic shuttle 102 can be fixedly coupled to the integration assembly 100 by one or more fasteners. In one embodiment, fasteners such as screws, bolts, or pins can pass through apertures defined by a portion of the integration assembly 100 and engage corresponding apertures on the electronic shuttle 102, to ensure a secure and stable connection between the electronic shuttle 102 and the integration assembly 100. In alternative embodiments, other fastening mechanisms can be employed, such as sliding locks or rotating latches for securing the electronic shuttle 102 in place, while allowing for quick and reliable attachment.

Mounting the electronic shuttle 102 to the integration assembly 100 in this manner provides several advantages. It creates a stable platform for the display and control mechanisms housed within the electronic shuttle 102, ensuring that the user can operate the system without unnecessary movement or vibration. Additionally, the integration assembly 100 offers a convenient location for the storage of excess umbilical cord 106. By neatly organizing and securing the umbilical cord 106, the integration assembly 100 reduces the risk of tangling or creating a potential trip hazard, particularly in the confined space of an ice fishing shelter.

The integration assembly 100 further includes clamps 118, 120 that enable the user to easily connect and disconnect the transducer mounting rod 108. In some embodiments, the clamps 118, 120 can be configured to be operated with a single hand, allowing the user to efficiently transition the system between the in-use configuration and the transport configuration. For example, in some embodiments, the clamps can be turret-style clamps. A turret-style clamp refers to a type of clamp mechanism designed to secure a cylindrical object, such as a rod or pipe, by enclosing it within an aperture formed by two cooperating surfaces.

The clamps 118, 120 provide a reliable mechanism for securely holding the transducer mounting rod 108 in place during use while allowing the user to quickly clamp or unclamp the transducer mounting rod 108 as needed. The turret-style design enables operation with a single hand, even while the user is wearing a glove or mitten. The clamps 118, 120 are configured for ease of use, ensuring secure retention of the transducer mounting rod 108 without requiring additional tools.

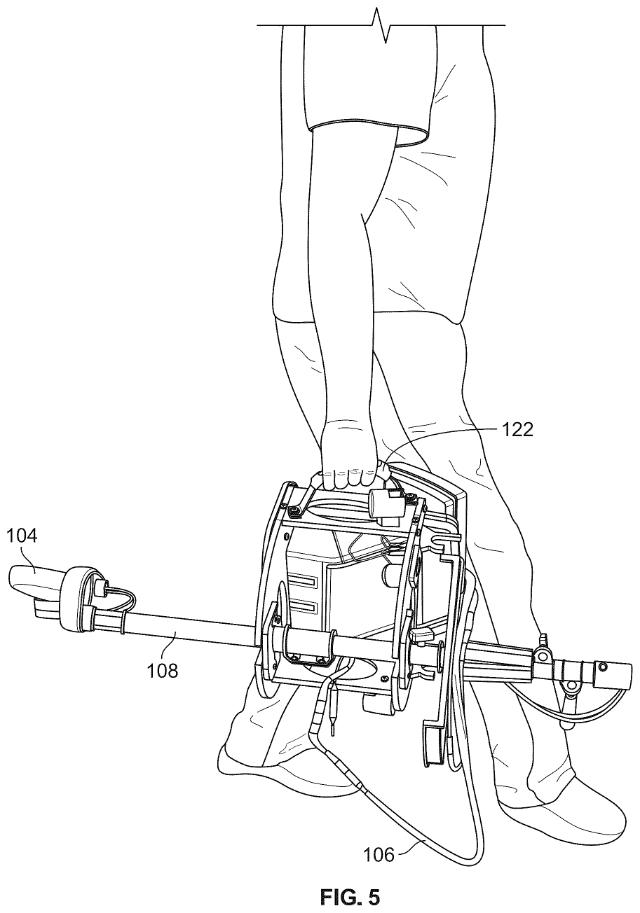

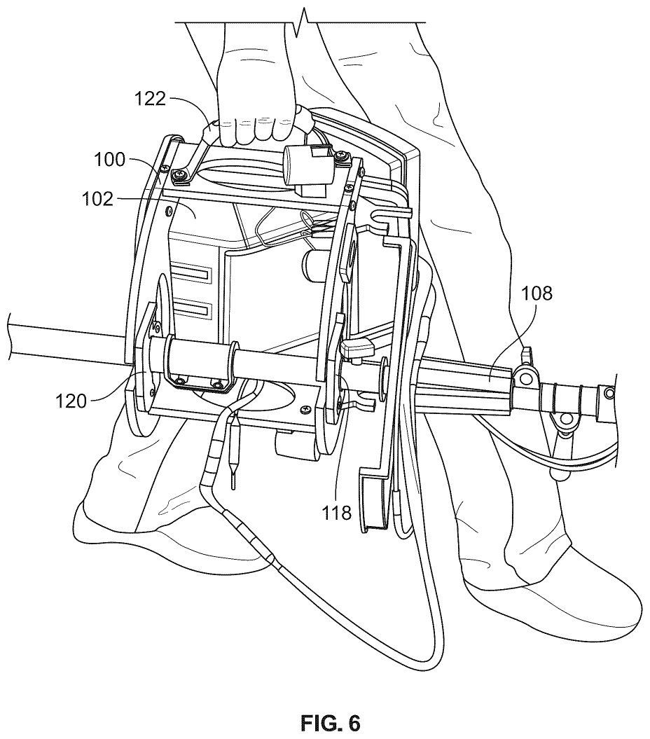

FIG. 5 illustrates the integration assembly 100 being carried in a transport configuration, and FIG. 6 provides a close-up view of the handle 122 mounted on the side of the integration assembly 100. In the transport configuration, the integration assembly 100 enables a user to carry multiple components of a forward-facing sonar system simultaneously, including the electronic shuttle 102, transducer 104, umbilical cord 106, and transducer mounting rod 108, using a single hand. This is facilitated by the handle 122, which is ergonomically positioned and securely mounted to the side of the integration assembly 100.

With the transducer mounting rod 108 secured within the clamps 118, 120, the integration assembly 100 can be carried with the transducer mounting rod 108 oriented in a substantially horizontal position. This horizontal orientation allows the user to fully extend their arm during transport, reducing physical fatigue and improving comfort, particularly when carrying the assembly over larger distances or across uneven surfaces. The horizontal positioning of the transducer mounting rod 108 also minimizes interference with the user's movement and surrounding objects. By consolidating the components of the sonar system into a single, manageable unit, the integration assembly 100 enhances portability and reduces the effort required to transport the system across different fishing locations.

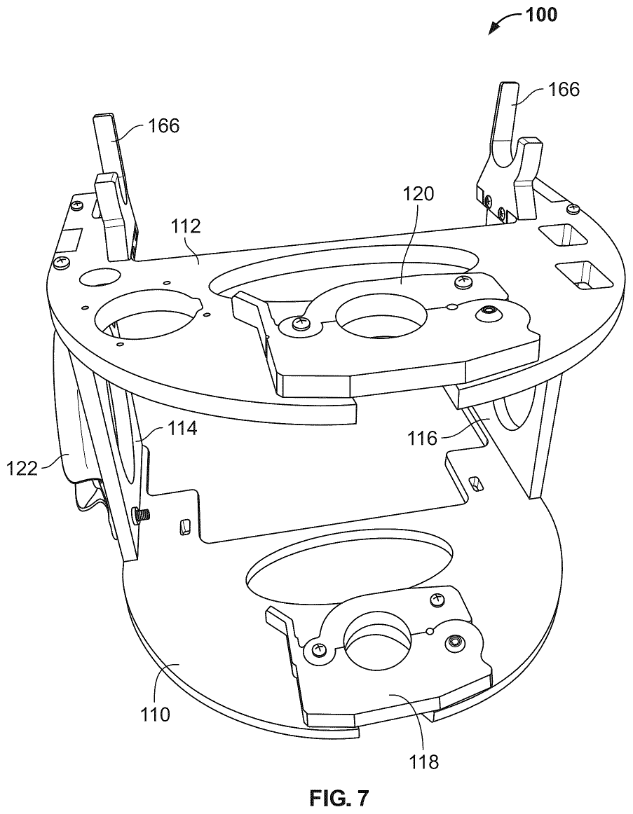

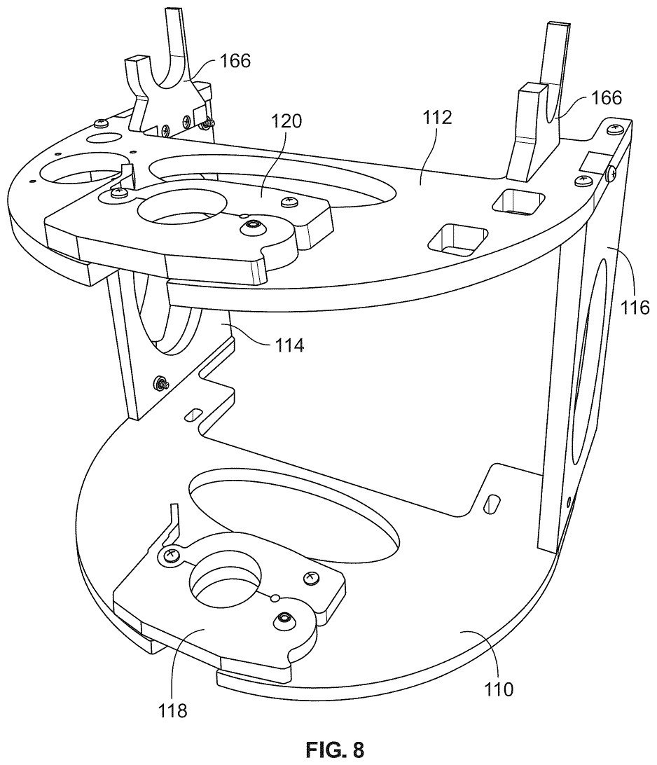

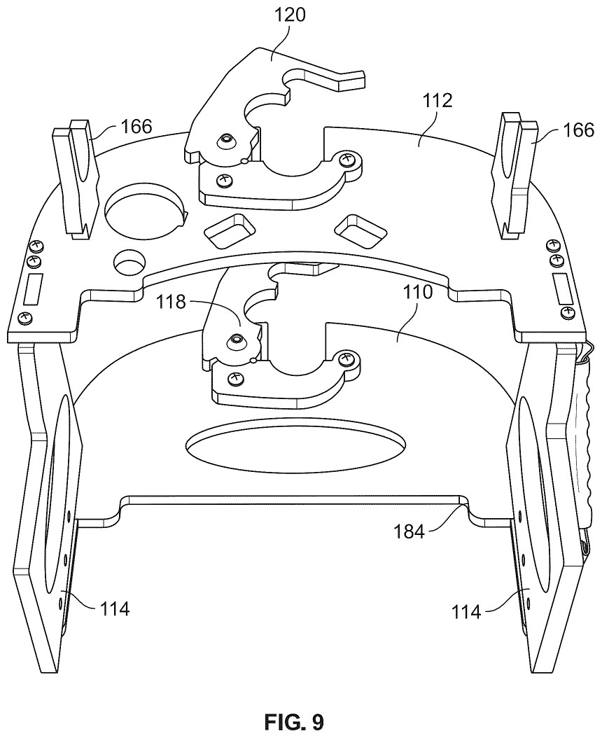

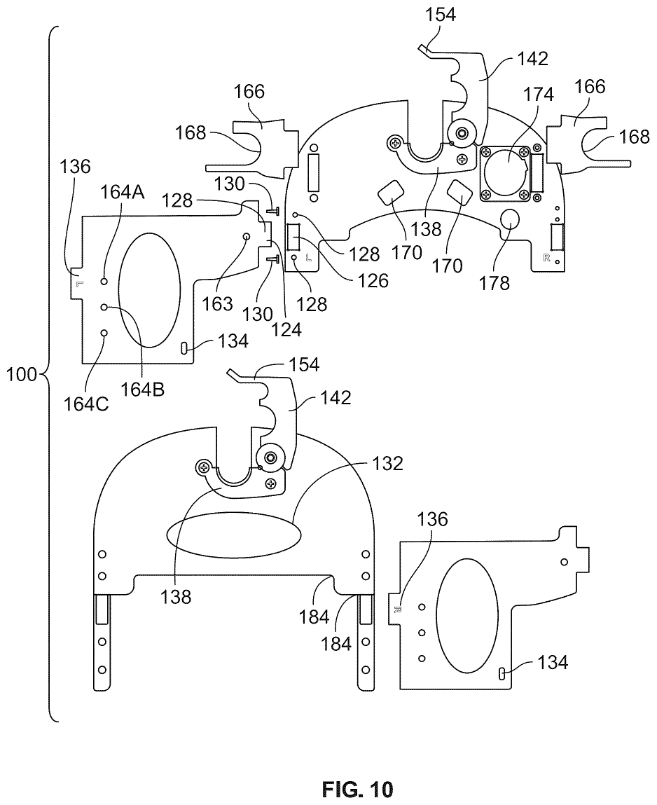

FIGS. 7-9 depict perspective views of the integration assembly 100, illustrating its structural configuration and layout. FIG. 10 provides a plan layout of the components of the integration assembly 100, depicting an interrelationship between its constituent elements. As depicted, the integration assembly 100 can include a base 110, a top 112, a first side 114, and a second side 116, collectively forming the structural framework of the integration assembly 100, and providing stability and support for components of the forward-facing sonar system.

In some embodiments, the base 110, top 112, first side 114, and second side 116 can be constructed from a planar material, such as high-density polyethylene (HDPE), or other material with suitable durability and resistance to low temperatures commonly encountered during ice fishing. The base 110 can be configured to support the integration assembly 100 on a supporting surface, such as the surface of the ice. The top 112 is coupled to the base 110 via the first side 114 and the second side 116, such that the top 112 is positioned a distance above the base 110, with both the top 112 and the base 110 forming planar portions. Similarly, the first side 114 and the second side 116 can also be oriented substantially parallel to one another, forming a rectangular or box-like structure.

In some embodiments, the integration assembly 100 incorporates a tab-and-slot joint to couple the structural components securely. As depicted in FIG. 10, the base 110 defines one or more slots 126, each configured to receive a corresponding tab 124 extending from either the first side 114 or the second side 116. In some embodiments, the connections are further defined by apertures 128 on opposite sides of the slots 126, enabling the insertion of one or more fasteners 130 to secure the respective sides 114 and 116 to the base 110 or top 112.

The planar construction of the base 110, top 112, first side 114, and second side 116, in combination with the tab-and-slot joint, forms a lightweight yet resilient framework optimized for supporting the electronic shuttle 102, transducer 104, and associated components during both in-use and transport configurations. The interlocking design of the tabs 124 and slots 126 ensures precise alignment and secure coupling of the structural components, providing a mechanically robust connection that enhances the overall stability and durability of the integration assembly 100.

In some embodiments, the various components of the integration assembly 100 can include markings to aid in their orientation during assembly. For example, the first side 114 and the second side 116 can be marked with identifiers 136 such as “R” and “L” to denote right and left sides, respectively, facilitating proper alignment and positioning during construction. These markings provide visual cues that simplify the assembly process and reduce the likelihood of errors.

To further enhance functionality, the components of the integration assembly 100 can include one or more material cutouts designed to reduce weight without compromising structural integrity. For instance, as best depicted in FIG. 10, the base 110 can include a material cutout 132 strategically positioned to minimize weight while maintaining the strength necessary to support the electronic shuttle 102, transducer 104, and other associated components. Such weight-reducing features improve the portability of the integration assembly 100, particularly in the transport configuration.

The integration assembly 100 is further configured to receive the electronic shuttle 102 within a cavity defined by the assembled components, thereby enabling the electronic shuttle 102 to be physically coupled to the integration assembly 100. In one embodiment, each of the first side 114 and the second side 116 can define one or more apertures 134, which are configured to allow fasteners (e.g., screws or bolts) to pass through and engage a corresponding threaded receptacle on the electronic shuttle 102. In some embodiments, the apertures 134 can be configured as slots, providing a range of tolerances to accommodate slight variations in dimensions and ensuring an improved fit for the electronic shuttle 102.

Additionally, at least one of the base 110 or the top 112 can define one or more steps 184 configured to receive a corresponding corner of the electronic shuttle 102. These steps 184 provide further stabilization, preventing unwanted movement of the electronic shuttle 102 during use or transport. As best depicted in FIG. 10, the base 110 can define a plurality of corners, allowing the integration assembly 100 to accommodate electronic shuttles of varying sizes. This versatility ensures that the integration assembly 100 can support a wide range of forward-facing sonar systems, enhancing its adaptability and utility across different fishing setups.

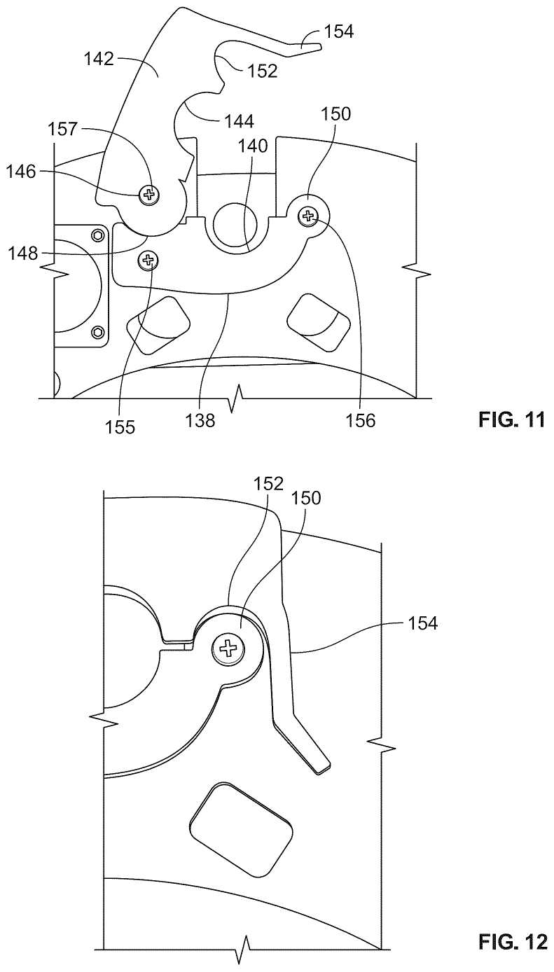

Each of the first clamp 118 and the second clamp 120 can be configured to securely hold the transducer mounting rod 108 in place while allowing for convenient attachment and detachment. With additional reference to FIGS. 11-12, each clamp 118, 120 can include a first part 138 and a second part 142. The first part 138 defines a first surface 140 configured to partially define an aperture shaped and sized to receive the transducer mounting rod 108. The second part 142 defines a second surface 144 that cooperates with the first surface 140 to form an aperture in a closed configuration. The aperture defined by the first and second surfaces 140, 142 can be sized to encircle or at least partially encircle the transducer mounting rod 108.

As shown in FIG. 11, each clamp 118, 120 can further define a pivot 146, which enables the first part 138 to pivot relative to the second part 142. In some embodiments, the pivot 146 can be integrally molded as a component of either the first part 138 or the second part 142. The pivot 146 can be configured to be received within a corresponding socket 148 defined by the opposite part, forming a durable and functional hinge mechanism. This design facilitates smooth and precise pivoting, allowing the clamp 118, 120 to open and close easily without the need for additional tools.

In some embodiments, the first part 138 of each clamp 118, 120 can be coupled to either the base 110 or the top 112 via a first fastener 155 and a second fastener 156. The second part 142 can be coupled to the corresponding base 110 or top 112 via a third fastener 157, which may pass through the center of the pivot 146. This configuration ensures secure attachment of both parts of the clamp 118, 120 to the integration assembly 100 while preserving the pivoting functionality of the second part 142 relative to the first part 138.

As further depicted in FIG. 12, each clamp 118, 120 can incorporate a snap-fit latch mechanism configured to securely hold the first part 138 and the second part 142 together in the closed configuration. In such embodiments, the first part 138 or the second part 142 can define a latch 150, such as a semicircular projection, while the opposite part defines a corresponding receptacle 152. The receptacle 152 can be configured as a circular cutout extending slightly more than 180° around the latch 150, thereby forming an over-center securement mechanism. This configuration encourages retention of the latch 150 within the receptacle 152, as the over-center engagement applies resistive force to inhibit unintentional disengagement.

In some embodiments, the receptacle 152 can also be operably coupled to a handle portion 154, enabling the user to selectively deform or manipulate the receptacle 152. This operability allows the latch 150 to be positioned within or removed from the receptacle 152 as needed. The over-center securement mechanism ensures a robust and stable connection when the clamp 118, 120 is in the closed configuration, while still allowing for efficient opening and closing of the clamp without additional tools. This design enhances the reliability and usability of the integration assembly 100 during both in-use and transport configurations.

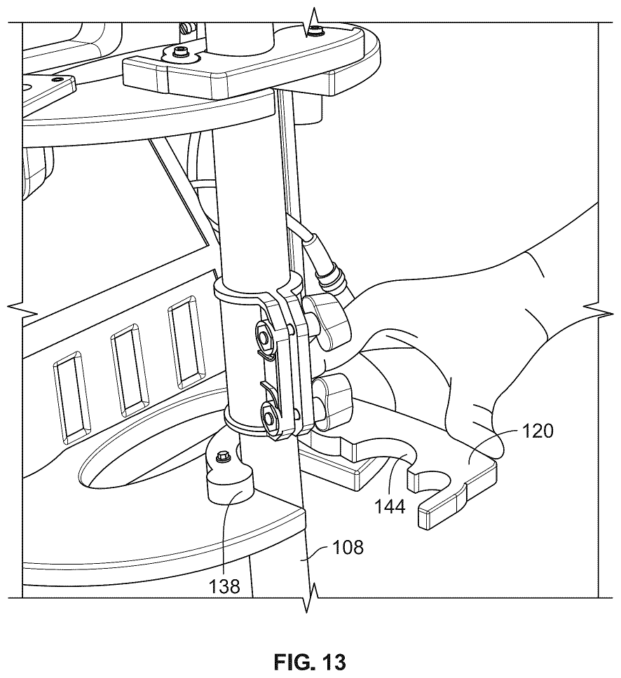

As depicted in FIG. 13, a user can secure the transducer mounting rod 108 to the integration assembly 100 by locking the clamps 118, 120 around the transducer mounting rod 108. In this configuration, the first surface 140 and the second surface 144 cooperate to form an aperture sized and shaped to surround the transducer mounting rod 108 when positioned therein. The axis of rotation of the pivot 146, and the corresponding orientation of the transducer mounting rod 108 within the aperture, is aligned along a first axis 160. This configuration provides a secure and stable connection, allowing the user to confidently secure the transducer mounting rod 108 in place during use, even while wearing gloves or handling additional equipment with the other hand.

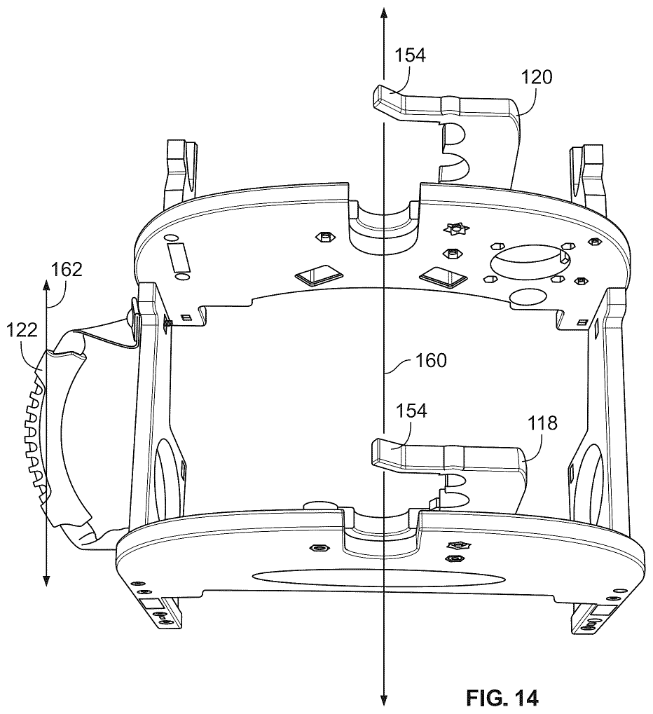

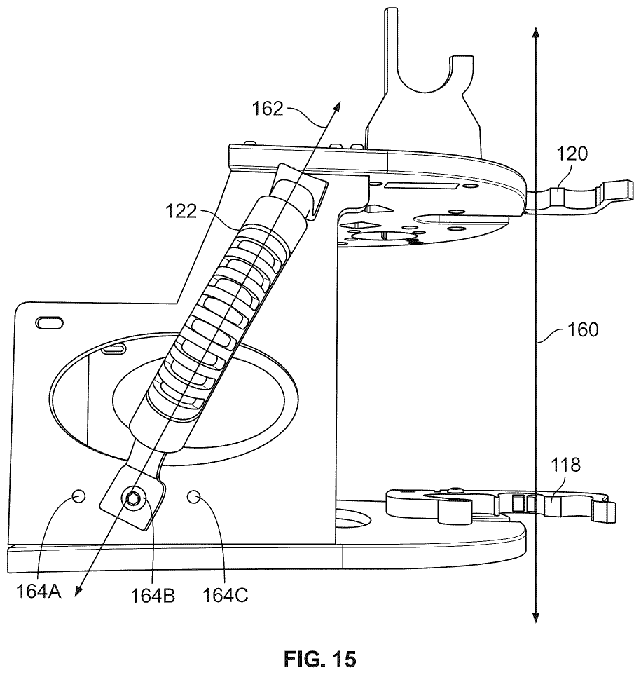

With additional reference to FIGS. 14-15, the integration assembly 100 can include a handle 122 configured to facilitate transport of the assembly. The handle 122 includes a grasping portion 164 that is configured to provide a secure and comfortable interface for the user. In some embodiments, the handle 122 can be constructed from a flexible material, including at least one of a nylon webbing, a thermoplastic elastomer, or a rubberized polymer, providing both durability and ergonomic comfort. As best depicted in FIG. 14, the grasping portion 164 of the handle 122 generally extends along a second axis 162, which in some embodiments is generally parallel to the first axis 160 within one plane. As further depicted in FIG. 15, the grasping portion 164 can also be angled with respect to the first axis 160 along a second plane orthogonal to the first plane. In one embodiment, the second axis 162 along which the grasping portion 164 generally extends forms an angle of less than 20 degrees with the first axis 160, providing a slight but ergonomic alignment optimized for transport.

The phrase “generally extends along,” as used herein, refers to the alignment of a structure, such as the grasping portion 164 of the handle 122, relative to a specified axis. This alignment does not necessitate the structure being perfectly linear or rigid but allows for minor deviations to accommodate practical considerations. Such deviations may arise from material properties, including the natural curvature or flexibility of materials such as fabric, rubber, or plastic, which can result in a non-linear shape. Additionally, ergonomic features, such as contours, finger grips, or other textural modifications, may be included to enhance user comfort and usability, even if they locally deviate from strict linearity. The phrase also encompasses design characteristics, such as molded grips, angled attachments, or aesthetic features, that provide functional or visual benefits while maintaining an overall alignment with the specified axis. This definition ensures that “generally extends along” is sufficiently broad to account for variations in structure while preserving the intended functional alignment.

To enhance adjustability, each of the first and second sides 114, 116 can define a plurality of handle connection apertures 163, 164A-C, enabling the grasping portion 164 of the handle 122 to be positioned at a desired angle relative to the first axis 160. For example, in one embodiment, each of the first and second sides 114, 116 can define at least three handle connection apertures 164A-C, allowing the user to select a preferred angle for the handle 122. Additionally, the handle 122 can be coupled to either the first side 114 or the second side 116, depending on the user's preferences, further improving the assembly's adaptability to various transport scenarios.

In some embodiments, the clamps 118, 120 can be oriented relative to the handle 122 to provide an added layer of security during transport. For instance, if either of the clamps 118, 120 inadvertently becomes unlatched during transport, the handle portion 154 of the clamps 118, 120 can serve to inhibit the full release of the transducer mounting rod 108. This feature is particularly effective when the clamps 118, 120 are configured to pivot no more than about 90° in the open configuration, preventing the transducer mounting rod 108 from being completely disengaged and ensuring continued retention during inadvertent latch failure.

With further reference to FIG. 10, the integration assembly 100 can include one or more transducer mounting rod supports 166 configured to provide additional versatility in positioning the transducer mounting rod 108. In some embodiments, the transducer mounting rod supports 166 can be coupled to the top 112 of the integration assembly 100 to facilitate the secure placement of the transducer mounting rod 108 in a generally horizontal orientation in the in-use configuration. For example, each of the transducer mounting rod supports 166 can define a notch or channel 168 shaped and sized to cradle the transducer mounting rod 108, ensuring stable positioning during use.

In some embodiments, the transducer mounting rod supports 166 can be coupled to the top 112 using a tab-and-slot joint, similar to the configuration used for joining the sides 114, 116 to the base 110 or top 112. The tab-and-slot design ensures precise alignment and a secure connection while allowing for easy assembly and disassembly without additional tools. This approach provides a robust yet flexible solution for accommodating the transducer mounting rod 108 in varying operational setups.

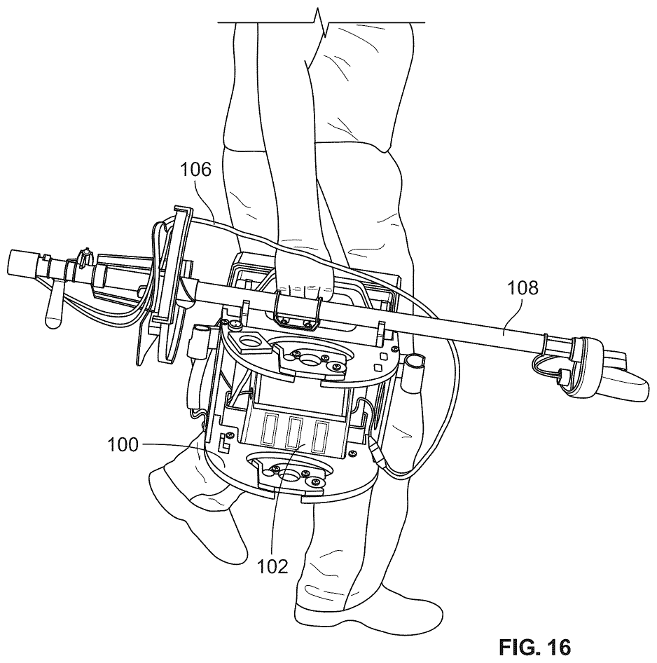

As depicted in FIG. 16, in embodiments where the electronic shuttle 102 includes a handle, the integration assembly 100 can be transported with the transducer mounting rod 108 resting on the transducer mounting rod supports 166. This configuration allows the transducer mounting rod 108 to be carried in a generally horizontal orientation, similar to the transport configuration. By resting the transducer mounting rod 108 on the transducer mounting rod supports 166, the user can carry the integration assembly 100 with a full arm extension.

With continued reference to FIG. 10 and additional reference to FIG. 17, in some embodiments, the integration assembly 100 can define a plurality of tool holders 170 configured to securely retain various tools commonly used in ice fishing activities. In some embodiments, the tool holders 170 can be integrally formed within at least one of the structural components of the integration assembly 100, such as the top 112. This integral design eliminates the need for additional attachments, providing a streamlined and compact solution for tool storage.

As depicted in FIG. 17, the tool holders 170 can be shaped and sized to accommodate a variety of tools, including but not limited to needle-nose pliers, line cutters, and other fishing accessories. The tool holders 170 ensure that essential tools are readily accessible during use, enhancing the overall efficiency of the ice fishing process. The positioning of the tool holders 170 on the top 112 also reduces clutter and ensures that tools remain securely stored when not in use, minimizing the risk of misplacement or accidental loss.

In some embodiments, the integration assembly 100 can further include one or more fishing rod holders 172, which can be operably coupled to the sides 114, 116 of the integration assembly 100. The fishing rod holders 172 can be designed to securely retain fishing rods during transport or while the assembly is in the in-use configuration. In some embodiments, the fishing rod holders 172 can be adjustably mounted to the sides 114, 116, allowing users to position the holders at preferred angles for ease of access or storage.

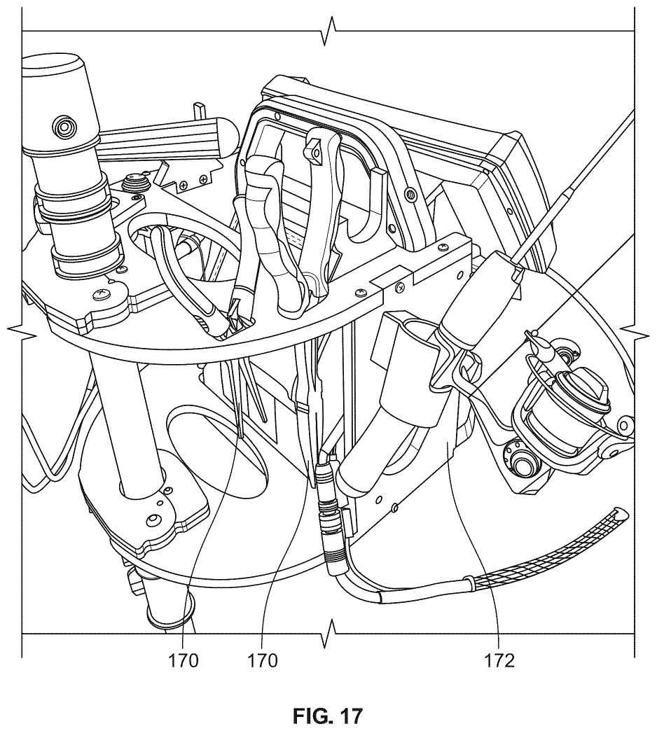

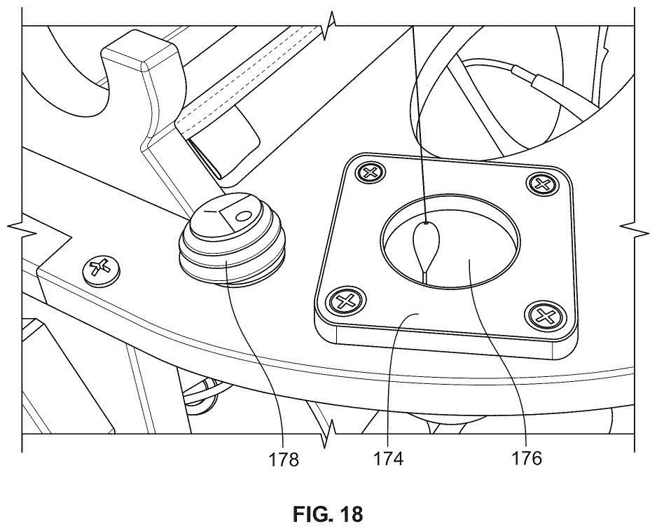

As further depicted in FIG. 18, the integration assembly 100 can include a lure charger 174 configured to enhance the functionality of the assembly by providing a convenient mechanism for charging luminescent fishing lures. In embodiments, the lure charger 174 includes a light-emitting component 176, such as an LED, designed to emit light at a wavelength suitable for activating the luminescent properties of fishing lures. This feature allows users to prepare their lures for optimal visibility and effectiveness in low-light or underwater conditions, commonly encountered during ice fishing.

In some embodiments, the lure charger 174 further includes a dedicated power switch 178, enabling the user to selectively activate or deactivate the light-emitting component 176 as needed. This dedicated switch provides control over the operation of the lure charger 174, ensuring efficient power usage and preventing unnecessary activation. Additionally, the lure charger 174 can be equipped with a connector configured to interface with a power accessory port of the electronic shuttle 102. This configuration allows the lure charger 174 to draw power directly from the electronic shuttle 102, eliminating the need for additional power sources and streamlining the overall operation of the assembly.

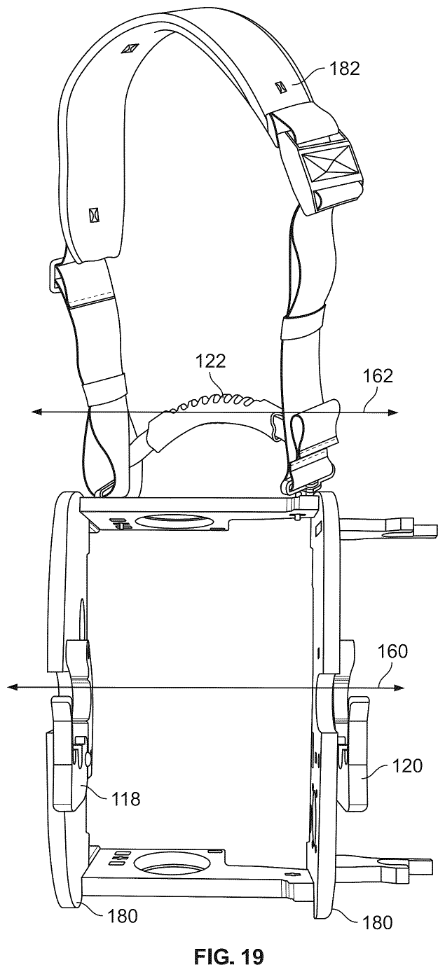

As further depicted in FIG. 19, the base 110 of the integration assembly 100 can include one or more feet 180 positioned on a side opposite the handle 122. The feet 180 are configured to provide stability when the assembly is set down in the transport configuration, ensuring that the integration assembly 100 remains securely upright on a supporting surface. This feature minimizes the risk of tipping or damage to the electronic shuttle 102 or other components during temporary placement in the transport configuration.

In some embodiments, the feet 180 can be coupled to either the first side 114 or the second side 116, positioned opposite the handle 122. This arrangement ensures that the assembly can rest stably on its side when rotated to the transport configuration. The feet 180 may be constructed from durable materials, such as high-density polyethylene or rubberized components, to provide additional traction and prevent slippage on icy or uneven surfaces.

Further, the integration assembly 100 can include a shoulder strap 182 configured to facilitate hands-free transportation of the assembly in the transport configuration. The shoulder strap 182 can be operably coupled to the assembly, for example, by attaching to the first side 114 and the second side 116 at designated strap connection points. In some embodiments, the shoulder strap 182 can be adjustable to accommodate users of different heights and preferences, enhancing comfort during extended carrying periods.

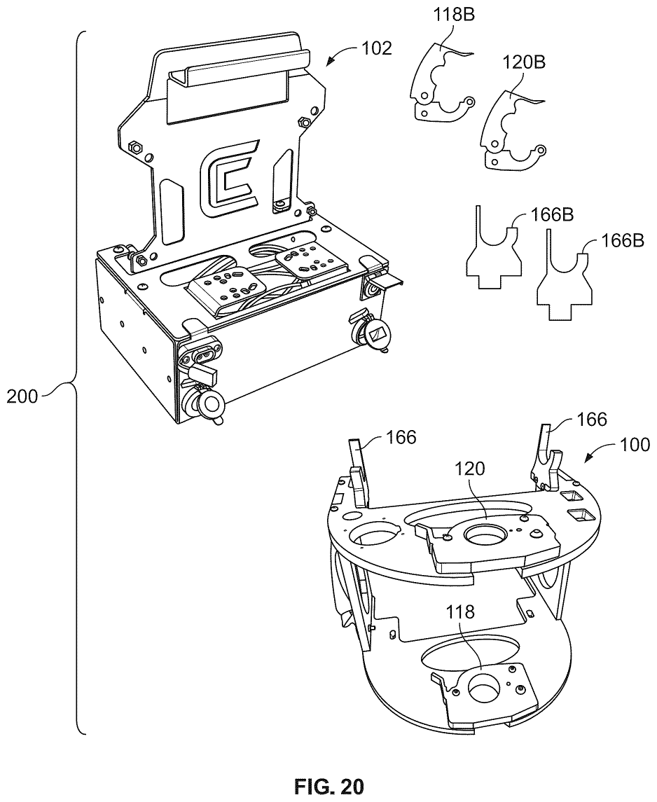

As depicted in FIG. 20, the integration assembly 100 can be designed to be compatible with a wide range of electronic shuttles 102 from different manufacturers, enhancing its versatility and utility across various ice fishing setups. To accommodate these variations, the integration assembly 100 can include features such as multiple sized steps 184 configured to receive corresponding corners of electronic shuttles 102 of different dimensions. These steps ensure secure seating of the electronic shuttle 102, regardless of size, providing stability during both in-use and transport configurations.

In addition to the variable steps 184, the integration assembly 100 can include a plurality of different-sized clamps 118B, 120B, and transducer mounting rod supports 166B to accommodate transducer mounting rods 108 and electronic shuttles 102 of varying dimensions. For instance, clamps 118B, 120B can be designed with apertures of different diameters to fit transducer mounting rods 108 from a variety of manufacturers. Similarly, transducer mounting rod supports 166B can define notches or channels 168B with different widths and depths, ensuring compatibility with a wide range of transducer mounting rods 108 and operational requirements.

To further enhance adaptability, the integration assembly 100 can incorporate additional adaptation tools, such as spacers and fasteners, configured to accommodate ice fishing components from various manufacturers. For example, spacers can be used to adjust the height or alignment of an electronic shuttle 102 within the assembly, ensuring a snug and stable fit. Custom fasteners can also be provided to interface with manufacturer-specific mounting points or configurations, allowing the integration assembly 100 to seamlessly integrate with diverse ice fishing electronics systems.

In some embodiments, the components of the electronic shuttle 102 can be integrated directly into the structure of the integration assembly 100, forming a unified device that combines the functionality of both systems. This integrated configuration eliminates the need for a separate electronic shuttle, thereby streamlining the overall setup and enhancing portability.

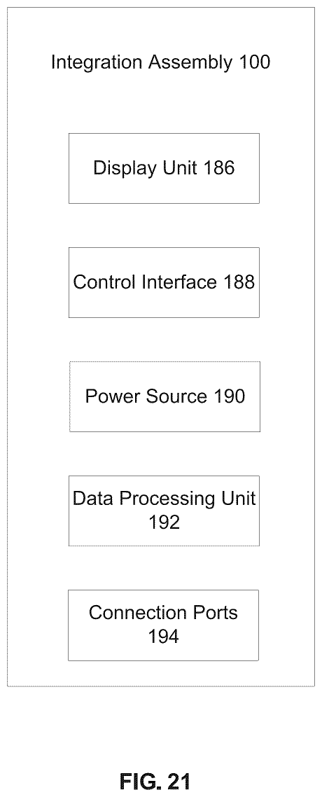

As depicted in FIG. 21, the electronic shuttle 102 typically includes several components, each performing a distinct function to support sonar system operation. A display unit 186 provides a visual interface for real-time sonar data, allowing the user to monitor underwater conditions and fish activity. A control interface 188 enables the user to configure and operate the sonar system, including adjustments for depth, range, and sensitivity settings. A power source 190 supplies energy to the system, often through a rechargeable battery, ensuring reliable operation during prolonged use. A data processing unit 192 processes sonar signals and converts them into visual data for display on the screen, enabling intuitive interpretation by the user. Connection ports 194 facilitate the attachment of peripheral components, such as a transducer or additional sensors, to extend the system's functionality.

In an embodiment where the electronic shuttle 102 is integrated into the integration assembly 100, the system can include a first clamp 118 and a second clamp 120, spaced apart and configured to selectively grip a transducer mounting rod 108 in a vertical orientation. The base 110 of the integrated electronic shuttle 102 is designed to rest securely on a supporting surface, such as ice, during use. This configuration ensures stability while allowing the user to operate the system with ease.

The integrated electronic shuttle 102 can further include a handle 122 mounted to a side of the assembly, enabling convenient transport while preserving the system's functionality. In this embodiment, the handle 122 allows the electronic shuttle 102 to be carried with the transducer mounting rod 108 still secured within the first clamp 118 and the second clamp 120. This design eliminates the need to disassemble the system during transport, significantly reducing setup time and effort when moving between fishing locations.

By integrating the electronic shuttle 102 into the structure of the integration assembly 100, the design provides a seamless user experience that combines display, control, and transport functions into a single, compact device. This configuration offers ice anglers an efficient solution for managing their sonar systems, enhancing usability and convenience in challenging fishing environments.

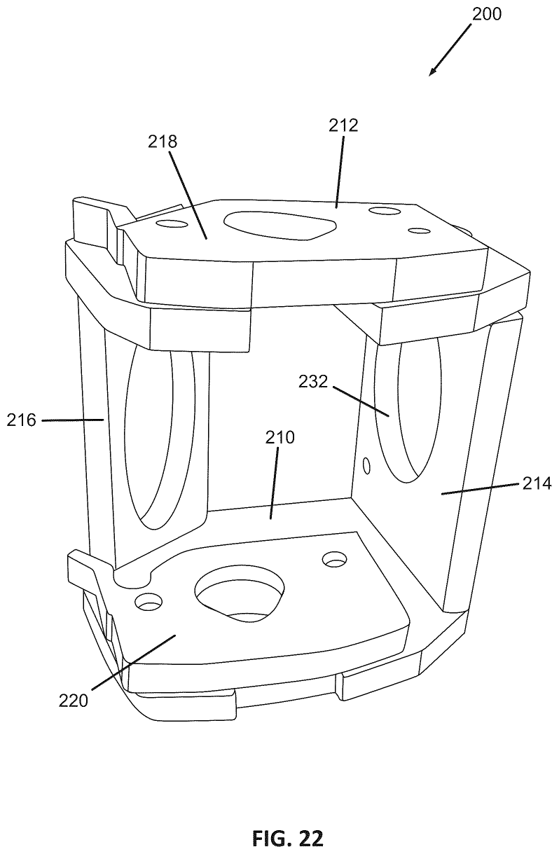

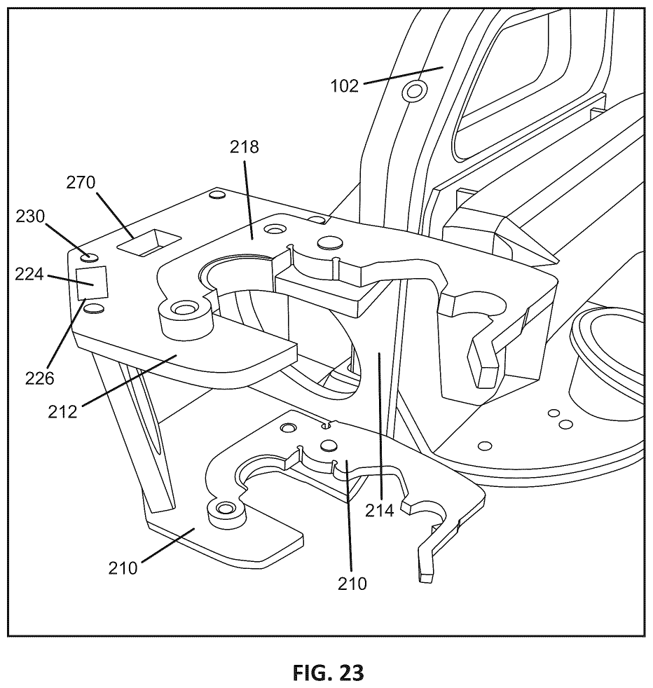

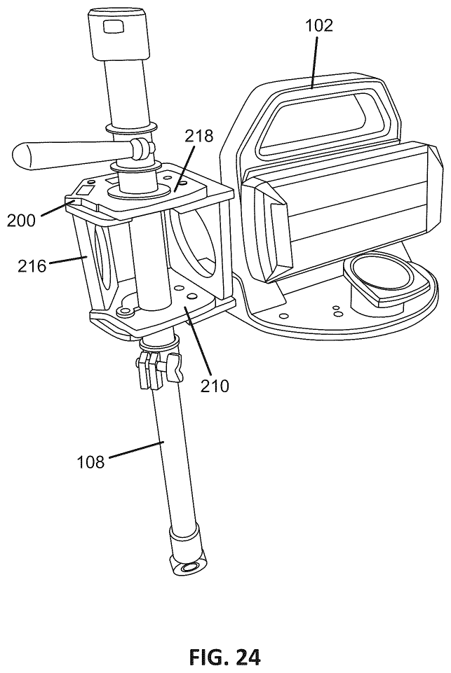

Referring to FIGS. 22-26, alternative embodiments of an integration assembly 200, 200′ are depicted in accordance with the disclosure. As depicted, the integration assembly 200, 200′ is configured as a more streamlined support structure for securing an electronic shuttle 102 to a transducer 104 in an ice fishing environment. In particular, unlike integration assembly 100, which straddles the electronic shuttle 102, the integration assembly 200, 200′ is designed to couple to one side of the electronic shuttle 102, thereby minimizing its footprint and reducing interference with other ice fishing equipment. For example, in some embodiments, the integration assembly 200, 200′ is configured for enabling a fishing line to be positioned in the same hole in the ice as the transducer 104.

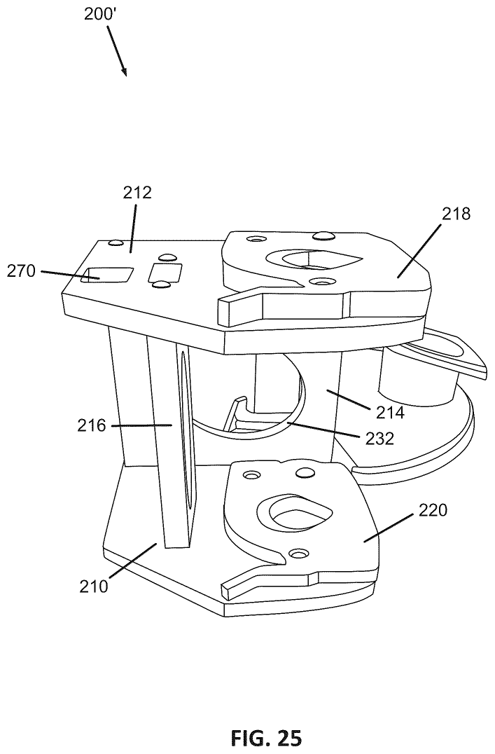

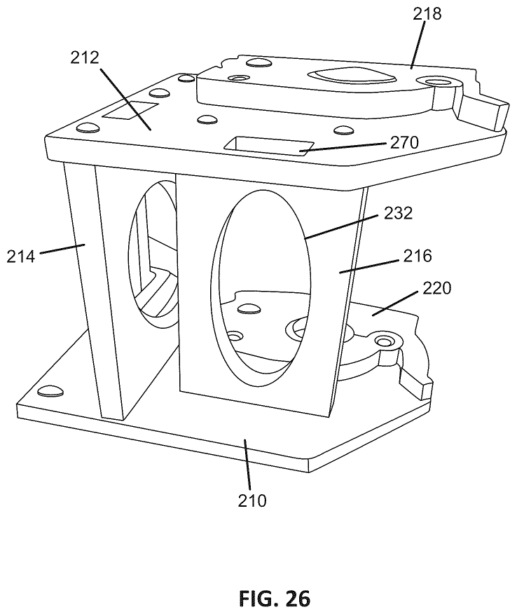

The integration assembly 200, 200′ comprises a base 210, a top 212, a first side 214, and a second side 216, which can be constructed from a planar material such as HDPE or another material with sufficient durability. The base 210 is configured to support the integration assembly 200, 200′ on a supporting surface, such as ice, while the top 212 is spaced above the base 210 and coupled to it via the first side 214 and the second side 216. As depicted in FIGS. 22-24, in one embodiment, the second side 216 is positioned at an angle (e.g., approximately 45°) relative to the first side 214, thereby reducing the overall profile of the integration assembly 200. Alternatively, as depicted in FIGS. 25-26, in another embodiment, the second side 216 is positioned substantially orthogonal (e.g., approximately 90°) relative to the first side 214, where both the first side 214 and the second side 216 define planar panels. These configurations allows for a more compact form factor while providing structural support for the electronic shuttle 102 and the transducer 104.

In some embodiments, the integration assembly 200, 200′ utilizes a tab-and-slot joint to securely couple the structural components. As depicted, the base 210 can define one or more slots 226, each configured to receive a corresponding tab 224 extending from either the first side 214 or the second side 216. In some embodiments, the connections are further defined by apertures, enabling the insertion of one or more fasteners 230 to secure the first side 214 and the second side 216 to the base 210 or the top 212. Additionally, as best depicted in FIG. 22, the base 210 can include a material cutout 232 to minimize weight while maintaining the necessary strength to support the electronic shuttle 102 and transducer 104. This weight-reducing feature improves the portability of the integration assembly 200, 200′, particularly in transport configurations.

In some embodiments, one or more tool holders 270 can be integrally formed within at least one of the structural components of the integration assembly 200, 200′. For example, in some embodiments, the tool holders 270 can be integrated into the top 212, providing convenient storage for tools such as pliers, hook removers, or other ice fishing accessories. The integration of the tool holders 270 within the structural components reduces the need for additional attachments, maintaining the streamlined and compact form of the integration assembly 200, 200′ while enhancing its functionality.

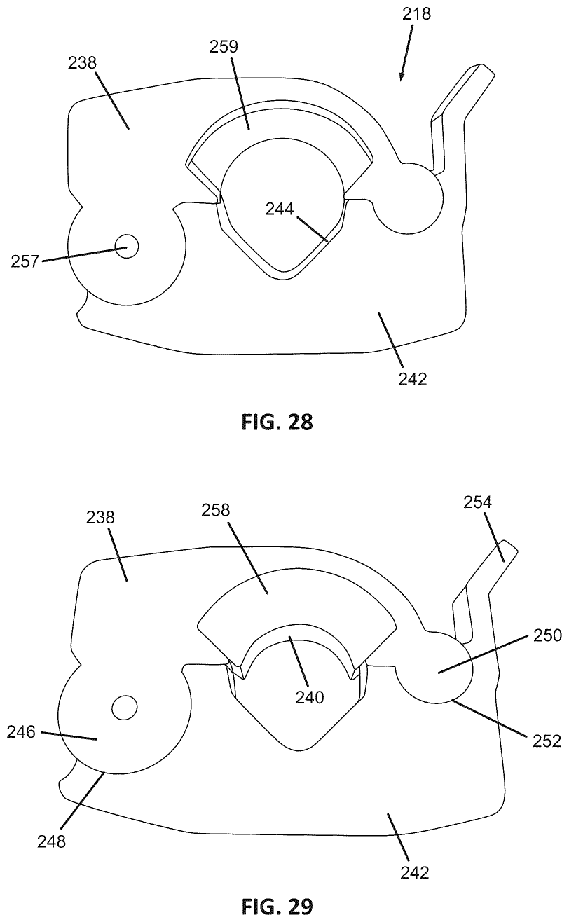

As depicted, the integration assembly 200, 200′ includes a first clamp 218 and a second clamp 220, which are configured to securely retain a transducer mounting rod 108 while allowing for convenient attachment and detachment. FIGS. 25-29 feature example embodiments of a clamp 218. As depicted, the clamp 218 can include a first part 238 and a second part 242, which cooperate to form an aperture that encircles or at least partially encircles the transducer mounting rod 108 when in a closed configuration.

As best depicted in FIG. 25, to enhance adaptability, the clamp 218 can include one or more sizing inserts 258A, 258B, 258C, which can be positioned within a corresponding receptacle 259 defined by the first part 238. These sizing inserts 258 enable the clamp 218 to accommodate transducer mounting rods 108 of varying diameters. Each sizing insert 258 can include a retainer portion 261, which is configured to be received within the receptacle 259, and a lip portion 263, which serves as the first surface 240 when the clamp 218 is in a closed configuration.

The sizing inserts 258 provide a modular solution for users who may use different transducer mounting rods 108 with varying diameters. By inserting the appropriate sizing insert 258, the aperture defined by the clamp 218 can be adjusted to securely retain the transducer mounting rod 108 without excessive movement or play. Furthermore, securing the clamp 218 to either the top 212 or base 210 of the integration assembly 200 can serve to lock the sizing insert 258A, 258B, or 258C within the receptacle 259, effectively blocking its removal. This feature enhances stability and prevents unintended displacement of the insert during use or transport.

As depicted, the clamp 218 defines a pivot 246, which enables the first part 238 to pivot relative to the second part 242. In some embodiments, each of the first part 238 and second part 242 defines a portion of both the pivot 246 and a socket 248. For example, in one embodiment, the socket 248 extends through a portion of the thickness of the material defining the first part 238, while the remaining thickness forms the pivot 246. The second part 242 includes corresponding components that complete the pivot 246 and socket 248, thereby forming a durable hinge mechanism that allows smooth and precise pivoting.

The first surface 240, positioned on the first part 238, can have a semicircular profile, while a second surface 244, positioned on the second part 242, can have a substantially V-shaped profile, enabling both the transducer mounting rod 108 and the umbilical cord 106 to be positioned within the aperture defined between the first surface 240 and the second surface 244.

In some embodiments, the first part 238 of the clamp 218 can be secured to the base 210 or top 212 via a first aperture 255 and a second aperture 256 through which fasteners can be passed. The second part 242 can be secured to the corresponding base 210 or top 212 via a third aperture 257 through which a fastener is passed, which may extend through the center of the pivot 246, ensuring a stable connection while maintaining the pivoting functionality of the second part 242 relative to the first part 238.

As further depicted, the clamp 218 can include a snap-fit latch mechanism configured to securely hold the first part 238 and second part 242 together in the closed configuration. In some embodiments, either the first part 238 or second part 242 defines a latch 250, such as a semicircular projection, while the opposite part defines a corresponding receptacle 252. The receptacle 252 can be configured as a circular cutout extending slightly more than 180° around the latch 250, thereby forming an over-center securement mechanism. This over-center engagement applies resistive force to inhibit unintentional disengagement, ensuring that the clamp 218 remains securely fastened during use.

As further shown in the figures, the receptacle 252 can be operably coupled to a handle portion 254, allowing the user to selectively deform or manipulate the receptacle 252 to engage or disengage the latch 250. This feature allows for quick opening and closing of the clamp 218 without requiring additional tools. The over-center securement mechanism ensures a robust and stable connection in the closed configuration, enhancing the reliability and usability of the integration assembly 200, 200′ in both in-use and transport configurations.

While the clamp 218 has been described in the context of integration assembly 200, 200′, it is equally applicable to integration assembly 100. The modular sizing inserts 258, snap-fit latch mechanism, and pivoting hinge design provide a secure, adaptable, and user-friendly clamping system, making the clamp 218 suitable for securing transducer mounting rods and associated components in various configurations across different integration assemblies.

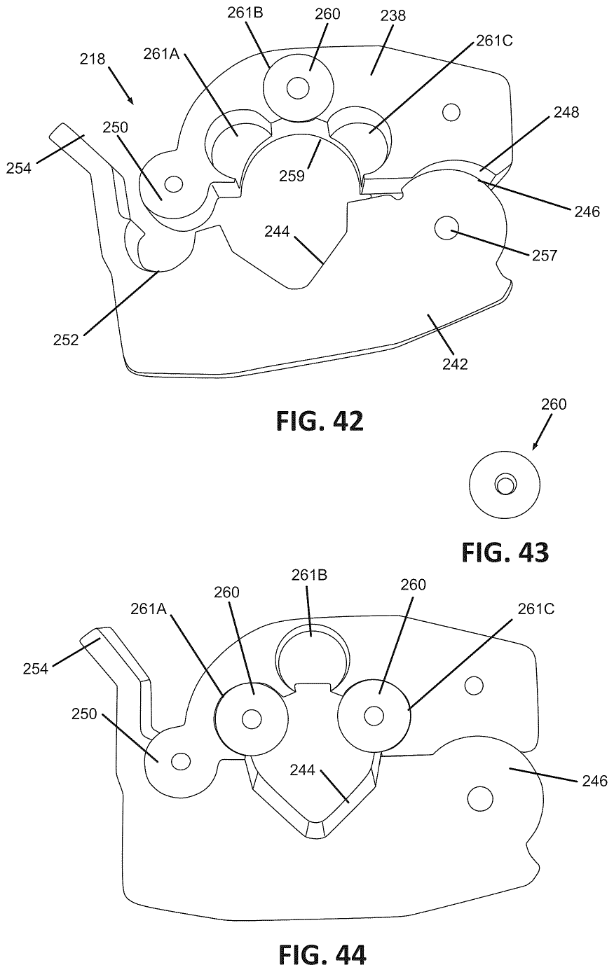

Referring now to FIGS. 42-44, an alternative embodiment of the clamp 218 is depicted. Similar to the embodiment described above, the clamp 218 includes a first part 238 and a second part 242 operably coupled together via a pivot 246. The first part 238 includes a socket 248 configured to receive a latch 250 extending from the second part 242, thereby enabling the clamp 218 to be selectively opened and closed. The second part 242 further includes a handle portion 254 and defines an aperture 257 that, in conjunction with the first part 238, forms a receptacle 252 for receiving and gripping a transducer mounting rod or other component.

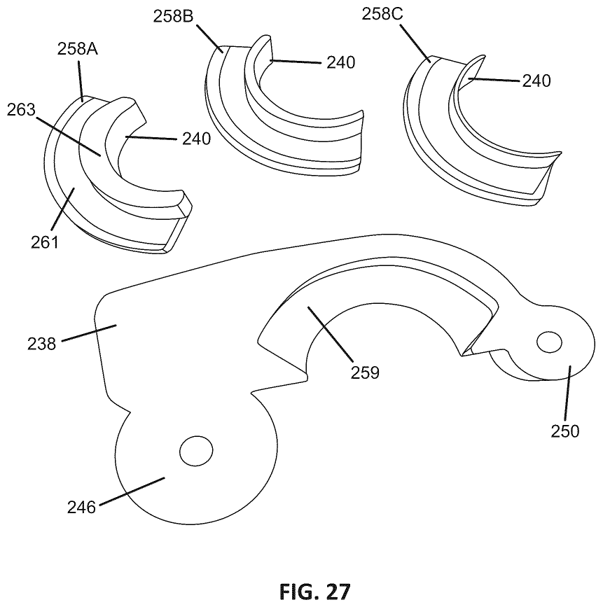

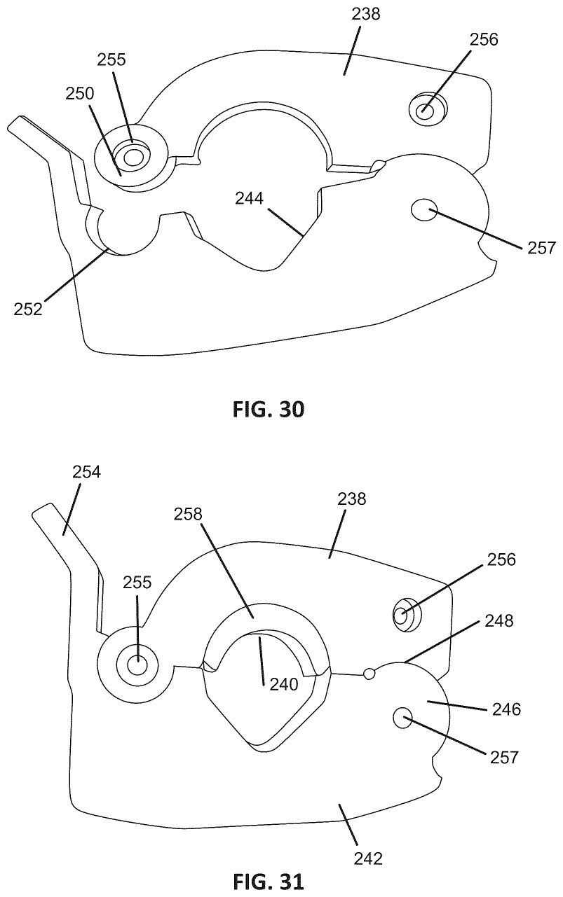

However, rather than utilizing modular sizing inserts as described in connection with FIGS. 27-31, this embodiment employs a plurality of plug receptacles formed in the first part 238 to enable adjustment of the grip diameter of the clamp 218. Specifically, as shown in FIG. 42, the first part 238 defines a default sized receptacle 259 that forms the main opening for receiving a transducer mounting rod. A plurality of plug receptacles, including a first plug receptacle 261A, a second plug receptacle 261B, and a third plug receptacle 261C, are formed in the second surface 244 of the first part 238.

The plug receptacles 261A, 261B, 261C are positioned such that they overlap with the wall forming the edge of the default sized receptacle 259. In the illustrated embodiment, the plug receptacles 261A, 261B, 261C have a cylindrical shape, though other shapes may be employed in alternative embodiments. By inserting cylindrically shaped plugs 260 (shown in FIG. 43) into one or more of the plug receptacles 261A, 261B, 261C, the effective diameter of the default sized receptacle 259 can be progressively reduced.

For example, as depicted in FIG. 42, insertion of a single plug 260 into the second plug receptacle 261B (the center receptacle) decreases the diameter of the opening to a first size, suitable for gripping a transducer mounting rod of a first diameter. As shown in FIG. 44, insertion of two plugs 260 into the first plug receptacle 261A and the third plug receptacle 261C further decreases the diameter to a second size, suitable for gripping a transducer mounting rod of a smaller diameter. If all three plug receptacles 261A, 261B, 261C are filled with plugs 260, the diameter is reduced to a third, smallest size.

In one embodiment, the plugs 260 are made of a rubber or elastomeric material, which not only fills the plug receptacles 261A, 261B, 261C to reduce the receptacle diameter, but also increases the friction between the clamp 218 and the transducer mounting rod, thereby enhancing the grip and reducing the likelihood of slippage. The plugs 260 may be press-fit or snap-fit into the plug receptacles 261A, 261B, 261C for easy insertion and removal, allowing the user to quickly adjust the clamp 218 to accommodate different rod diameters.

This plug-based adjustment system provides a simple and effective alternative to modular sizing inserts, offering users flexibility in customizing the clamp 218 to fit various transducer mounting rod sizes while maintaining the secure latching and pivoting functionality of the clamp design. Like the sizing insert embodiment, this alternative configuration is suitable for use in integration assemblies 100, 200, 200′ or any other application requiring adjustable clamping functionality.

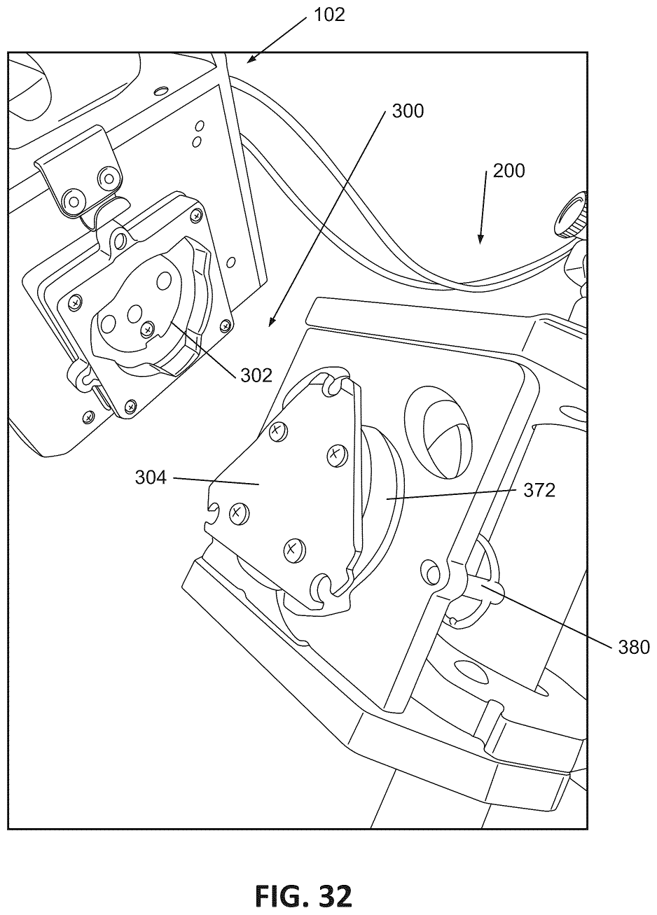

Referring to FIGS. 32-40, a swivel connection assembly 300 is depicted in accordance with an embodiment of the disclosure. The swivel connection assembly 300 enables pivotable and releasable coupling between the integration assembly 100 and the integration assembly 200, 200′. As depicted, the swivel connection assembly 300 provides a mechanism for selectively positioning the integration assembly 200, 200′ in multiple locked orientations relative to the integration assembly 100, thereby enhancing versatility during transport and use.

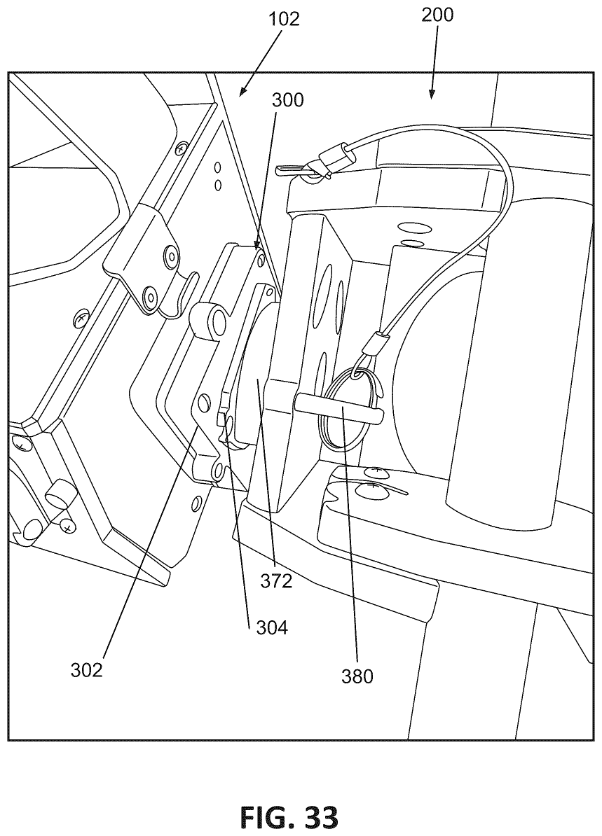

With reference to FIG. 32, the swivel connection assembly 300 comprises a female side 302 configured to couple to the integration assembly 100 and a male side 304 configured to couple to the integration assembly 200, 200′. The female side 302 and the male side 304 are shown separated in FIG. 32 to illustrate the mating surfaces and coupling features of each component. As further depicted in FIG. 33, when the male side 304 is engaged with the female side 302, the swivel connection assembly 300 enables a pivotable connection between the integration assembly 100 and the integration assembly 200, 200′, while maintaining secure retention during use and transport.

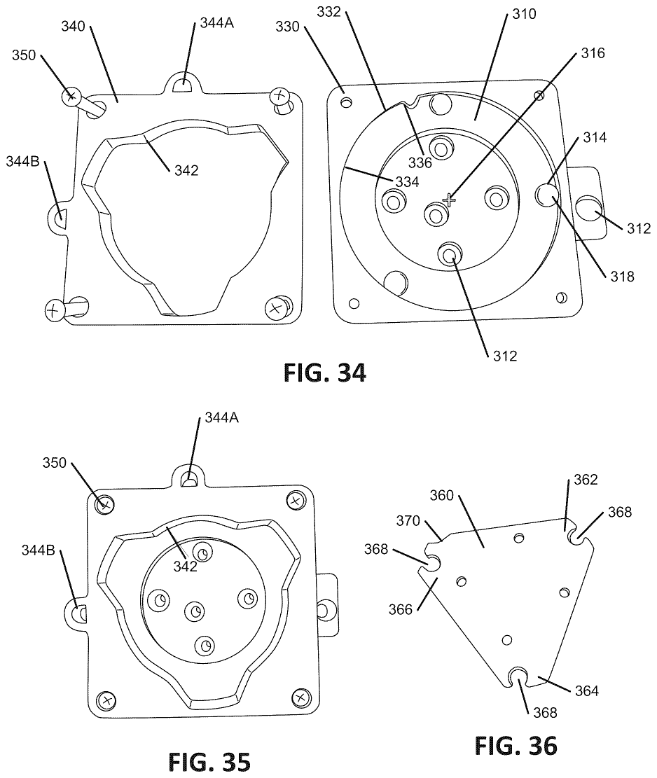

With additional reference to FIGS. 34-35, the female side 302 comprises a multi-layer construction including a base layer 310, a second layer 330, and a third layer 340, which are secured together to form a unitary assembly. As best depicted in FIG. 34, the base layer 310 can be constructed from a durable material, such as high-density polyethylene (HDPE), and defines a plurality of mounting apertures 312 configured to enable attachment of the female side 302 to the integration assembly 100. The mounting apertures 312 can be positioned to accommodate a variety of different makes and models of ice fishing integration assemblies, thereby enhancing compatibility and adaptability.

The base layer 310 further defines a plurality of ball bearing apertures 314 positioned radially around a center point 316. In some embodiments, three ball bearing apertures 314 are positioned within the base layer 310, each configured to receive a spring-loaded ball bearing 318. The spring-loaded ball bearings 318 are configured to interact with corresponding detents on the male side 304, as will be described in further detail below, to provide tactile feedback regarding the position of the male side 304 relative to the female side 302 and to aid in maintaining selected locked positions.

As further depicted in FIG. 34, the second layer 330 can be constructed from aluminum or another material with sufficient structural strength and rigidity. The second layer 330 defines a circular opening 332 having an inner wall 334. The circular opening 332 is sized to allow a male coupling plate 360 of the male side 304 to rotate freely therein. The inner wall 334 further defines a stop surface 336 configured to interact with a corresponding stop surface 370 on the male coupling plate 360 to inhibit full 360-degree rotation, thereby defining angular limits for the pivotable motion of the male side 304 relative to the female side 302.

The third layer 340 is positioned on top of the second layer 330, as depicted in FIG. 35, and defines a keyed opening 342 configured to receive the male coupling plate 360 during insertion. In some embodiments, the keyed opening 342 has a triangular shape that corresponds to the generally triangular profile of the male coupling plate 360, thereby enabling the male coupling plate 360 to be inserted through the keyed opening 342 when properly aligned. However, upon rotation of the male coupling plate 360 after insertion, the keyed opening 342 inhibits retraction of the male coupling plate 360, thereby locking the male side 304 to the female side 302 while still permitting pivoting motion.

As further shown in FIG. 35, the third layer 340 defines a pair of pin slots 344, including a first pin slot 344A and a second pin slot 344B. In some embodiments, the pin slots 344A, 344B are positioned on orthogonal sides of an otherwise square or rectangular perimeter of the third layer 340. The pin slots 344A, 344B are configured to receive a locking pin 380, enabling the user to selectively lock the integration assembly 200, 200′ in either a vertical orientation or a horizontal orientation relative to the integration assembly 100, as will be described in further detail below.

The base layer 310, second layer 330, and third layer 340 are secured together by fasteners 350, which in some embodiments comprise four fasteners positioned at the corners of the multi-layer assembly. The fasteners 350 ensure that the female side 302 functions as a unitary structure capable of withstanding the forces applied during coupling, pivoting, and use of the swivel connection assembly 300.

With reference to FIG. 36, the male side 304 comprises a male coupling plate 360 having a generally triangular shape. The male coupling plate 360 includes a first apex 362, a second apex 364, and a third apex 366, each corresponding to a corner of the triangular profile. Detents 368 are positioned at the apexes 362, 364, 366 of the male coupling plate 360, and are configured to interact with the spring-loaded ball bearings 318 of the female side 302. This interaction provides tactile feedback and resistance when the male coupling plate 360 is rotated to specific positions, thereby assisting the user in accurately positioning the integration assembly 200, 200′ at desired orientations.

As further depicted in FIG. 36, the male coupling plate 360 defines a stop surface 370 positioned on one or more edges of the triangular profile. The stop surface 370 is configured to engage the stop surface 336 of the inner wall 334 of the female side 302, thereby preventing further rotation of the male coupling plate 360 beyond a predetermined angular range. This hard stop mechanism ensures that the integration assembly 200, 200′ can only pivot within defined limits, enhancing safety and usability during operation.

In some embodiments, the male side 304 further includes a spacer 372 positioned between the male coupling plate 360 and the integration assembly 200, 200′. The spacer 372 has a thickness substantially equal to the thickness of the third layer 340 of the female side 302, thereby ensuring that the male coupling plate 360 can be fully inserted into the female side 302 without interference. The spacer 372 provides proper alignment and clearance, enabling smooth pivoting motion and reliable engagement of the detents 368 with the spring-loaded ball bearings 318.

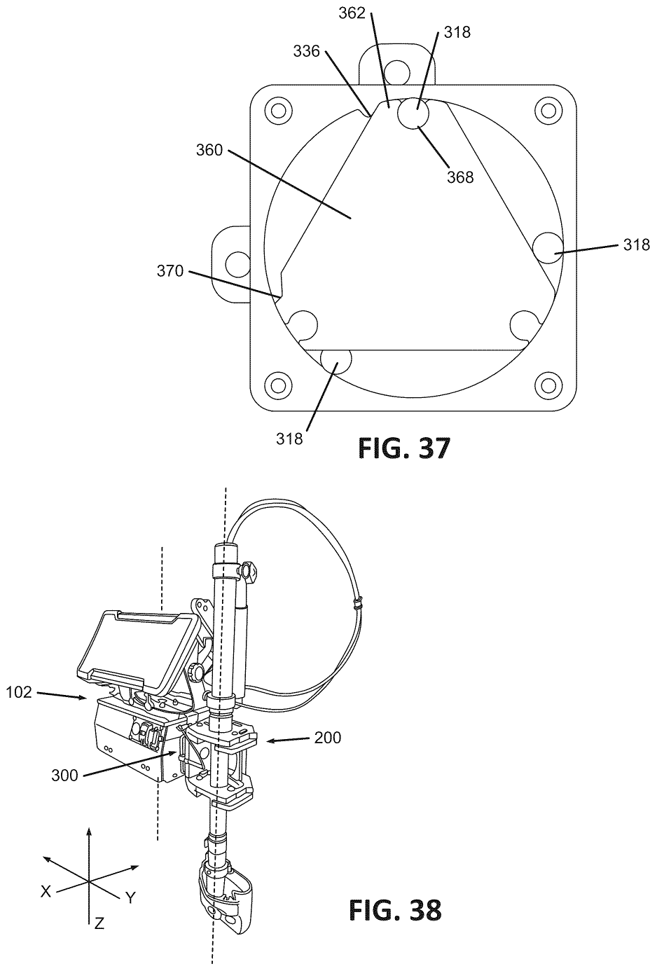

With reference to FIGS. 37-38, the swivel connection assembly 300 is depicted with the male coupling plate 360 positioned in a first locked position. In this configuration, the integration assembly 200, 200′ is oriented vertically relative to the integration assembly 100, thereby supporting the transducer mounting rod 108 in a vertical orientation. This vertical orientation is particularly advantageous during use, as it enables the transducer 104 to be positioned below the surface of the ice within an ice hole, facilitating optimal sonar imaging.

As best shown in FIG. 37, in the first locked position, one or more of the spring-loaded ball bearings 318 are received within corresponding detents 368 positioned on the male coupling plate 360, thereby providing tactile feedback and resistance to rotation. This engagement encourages the male coupling plate 360 to remain in the first locked position during use, preventing unintentional pivoting or misalignment. As further depicted in FIG. 38, the integration assembly 200, 200′ is securely positioned in the vertical orientation, allowing the user to deploy the transducer 104 for fishing operations.

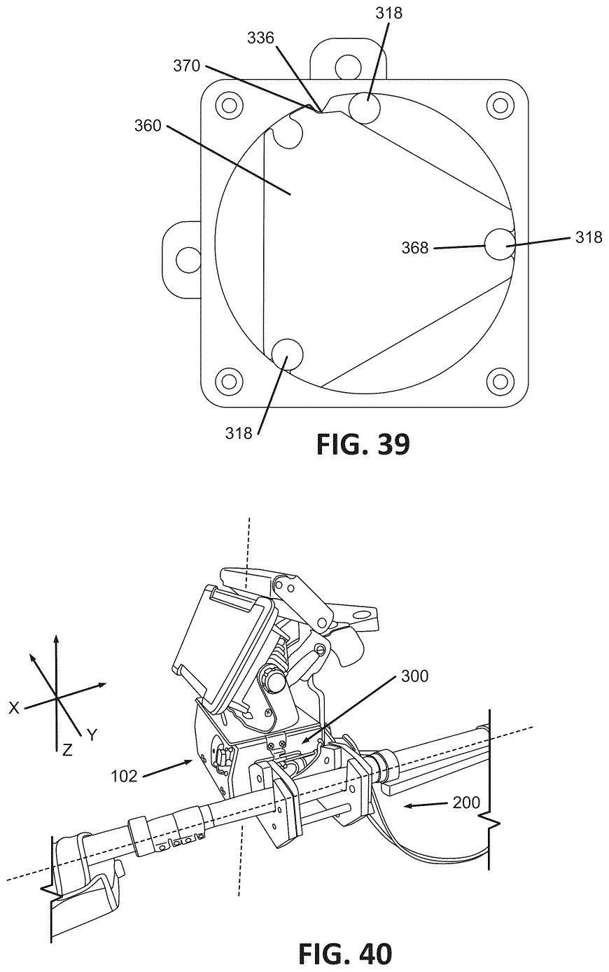

With additional reference to FIGS. 39-40, the swivel connection assembly 300 is depicted with the male coupling plate 360 positioned in a second locked position. In this configuration, the integration assembly 200, 200′ is oriented horizontally relative to the integration assembly 100, thereby supporting the transducer mounting rod 108 in a horizontal orientation. This horizontal orientation is particularly advantageous during transport, as it allows the user to carry the system in a compact and balanced configuration, reducing physical strain and facilitating movement between fishing locations.

As shown in FIG. 39, in the second locked position, a greater number of the spring-loaded ball bearings 318 are received within corresponding detents 368 on the male coupling plate 360, as compared to the first locked position. In some embodiments, two of the three spring-loaded ball bearings 318 engage with detents 368 in the second locked position, thereby providing enhanced stability and resistance to unintentional rotation. This configuration ensures that the integration assembly 200, 200′ remains securely positioned in the horizontal orientation during transport.

As further depicted in FIG. 39, the stop surface 370 of the male coupling plate 360 is positioned adjacent to or abutting the stop surface 336 of the inner wall 334 of the female side 302. This engagement defines the angular limit of rotation, preventing the male coupling plate 360 from pivoting beyond the second locked position. The hard stop provided by the interaction of the stop surfaces 336, 370 ensures reliable positioning and prevents over-rotation that could lead to misalignment or damage.

As further illustrated in FIG. 40, the integration assembly 200, 200′ is securely positioned in the horizontal orientation, allowing the user to transport the system with enhanced ease and efficiency. The swivel connection assembly 300 enables the user to quickly transition between the first locked position and the second locked position, providing versatility and convenience during both use and transport.

In some embodiments, the locking pin 380 can be inserted through one of the pin slots 344A, 344B to provide additional securement of the male coupling plate 360 in a selected locked position. The locking pin 380 extends through the pin slot 344A or 344B and engages a corresponding feature on the male coupling plate 360, thereby inhibiting rotation and providing an additional layer of security during use or transport. This feature is particularly advantageous in situations where the user desires to ensure that the integration assembly 200, 200′ remains locked in a specific orientation, even in the presence of external forces or vibrations.

The swivel connection assembly 300 provides a robust and user-friendly mechanism for coupling the integration assembly 100 and the integration assembly 200, 200′ while enabling selective positioning in multiple locked orientations. The combination of the keyed opening 342, spring-loaded ball bearings 318, detents 368, and stop surfaces 336, 370 ensures reliable engagement, tactile feedback, and defined angular limits, enhancing the overall usability and safety of the system. Additionally, the multi-layer construction of the female side 302 and the triangular profile of the male coupling plate 360 provide a mechanically robust connection capable of withstanding the forces encountered during ice fishing operations.

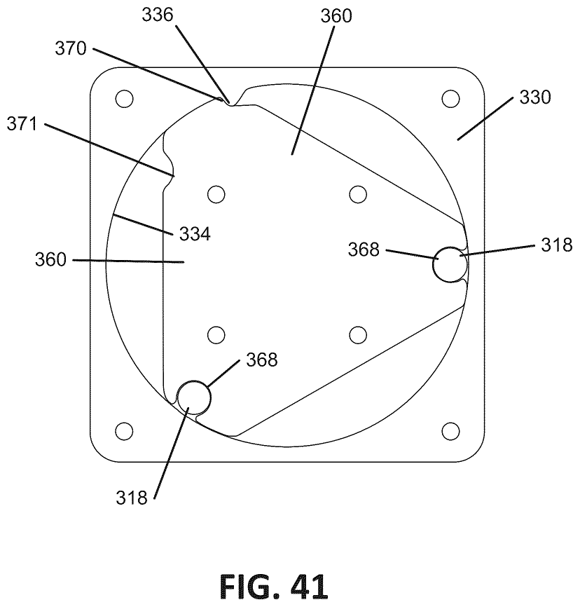

Referring now to FIG. 41, an alternative embodiment of the male coupling plate 360 for the swivel connection assembly 300 is depicted. Similar to the embodiment described above with reference to FIGS. 32-40, the male coupling plate 360 has a generally triangular profile defined by three apexes 362, 364, 366. However, in this embodiment, the male coupling plate 360 defines only two detents 368 rather than three detents as previously described.

Specifically, the detent 368 positioned closest to the stop surface 370 of the male coupling plate 360 is omitted in this configuration. Instead, a recess 371 is formed on the side of the male coupling plate 360 opposite the stop surface 370. The recess 371 is configured to interact with the spring-loaded ball bearings 318 of the female side 302. In one embodiment, the recess 371 provides a shallower engagement than the detents 368, creating a distinct tactile feedback when the male coupling plate 360 is rotated to this position.

Correspondingly, this embodiment includes only two spring-loaded ball bearings 318 rather than three. The spring-loaded ball bearings 318 are positioned within ball bearing apertures defined by the base layer and extend through the second layer 330 to interact with the detents 368 and recess 371 of the male coupling plate 360. The inner wall 334 of the second layer 330 defines the circular opening within which the male coupling plate 360 rotates.

The stop surface 370 of the male coupling plate 360 is configured to engage with a corresponding stop surface 336 on the female side 302, thereby limiting the rotational range of the male coupling plate 360. In this two-detent configuration, the swivel connection assembly 300 provides two primary locked positions corresponding to the two detents 368, with the recess 371 providing an intermediate position that may be used for temporary positioning or fine adjustment.

This alternative configuration may be advantageous in applications where only two primary locked positions are desired, or where the reduced number of ball bearings 318 simplifies manufacturing and assembly. The recess 371 provides tactile feedback to the user indicating an intermediate position while maintaining the security of the two fully locked positions defined by the detents 368.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. An ice fishing electronics integration assembly for use with an electronic shuttle and a transducer mounting rod, the assembly comprising:
a base configured to support the assembly on a supporting surface in an in-use configuration, the base further configured to couple to the electronic shuttle;
a first clamp operably coupled to the base; and
a second clamp positioned parallel to and spaced apart from the first clamp, the second clamp operably coupled to a structure spaced above the base,
wherein each of the first clamp and the second clamp is configured to secure the transducer mounting rod, and wherein an axis of rotation of a pivot of the first clamp is generally parallel to an axis of rotation of a pivot of the second clamp.

2. The assembly of claim 1, wherein each of the first clamp and the second clamp comprises a first part defining a first surface configured to partially define an aperture, and a second part pivotally connected to the first part, the second part defining a second surface configured to cooperate with the first surface to form the aperture in a closed configuration.

3. The assembly of claim 1, further comprising a handle including a grasping portion that generally extends along a second axis generally parallel to the axis of rotation of the pivot of the first clamp, the handle configured to facilitate transport of the assembly in a transport configuration.

4. The assembly of claim 3, wherein the second axis along which the grasping portion generally extends forms an angle of less than 20 degrees with the axis of rotation of the pivot.

5. The assembly of claim 1, wherein the base comprises a mounting interface configured to accommodate attachment to electronic shuttles from different manufacturers.

6. The assembly of claim 1, wherein at least one of the base or the structure spaced above the base is constructed from high-density polyethylene.

7. The assembly of claim 1, further comprising at least one accessory selected from the group consisting of: a tool holder, a rod holder, a lure charger, one or more feet, and a shoulder strap.

8. The assembly of claim 1, wherein each clamp further comprises an over-center snap-fit securement mechanism configured to retain the first part and second part in the closed configuration.

9. The assembly of claim 1, further comprising a second integration assembly operably coupled to a side of the base, the second integration assembly including a third clamp configured to secure the transducer mounting rod.

10. The assembly of claim 9, wherein the second integration assembly comprises a top positioned above the base and coupled to the base via a first side and a second side, wherein the second side is positioned at an orthogonal angle relative to the first side.

11. The assembly of claim 9, wherein the third clamp is configured to accommodate transducer mounting rods of different diameters via one or more removable sizing inserts.

12. The assembly of claim 9, wherein the third clamp defines a V-shaped profile configured to receive both the transducer mounting rod and an umbilical cord.

13. The assembly of claim 9, wherein the second integration assembly is coupled to the base via a swivel connection assembly, the swivel connection assembly enabling the second integration assembly to pivot between a first locked position and a second locked position.

14. The assembly of claim 13, wherein the swivel connection assembly comprises:
a female side coupled to the base, the female side defining a keyed opening;
a male side coupled to the second integration assembly, the male side including a male coupling plate having a keyed profile configured to be inserted through the keyed opening and rotated to lock the male side to the female side while permitting pivoting motion.

15. The assembly of claim 14, wherein the female side includes one or more spring-loaded ball bearings, and wherein the male coupling plate includes one or more detents configured to receive the spring-loaded ball bearings to provide tactile feedback in the first locked position and the second locked position.

16. The assembly of claim 14, wherein at least one of the female side or the male side includes a stop surface configured to limit rotational range of the male coupling plate relative to the female side.

17. The assembly of claim 13, wherein in the first locked position the second integration assembly is oriented vertically relative to the base, and wherein in the second locked position the second integration assembly is oriented horizontally relative to the base.

18. An ice fishing electronics integration assembly for use with an electronic shuttle and a transducer mounting rod, the assembly comprising:
a base configured to couple to a side of the electronic shuttle;
a first clamp operably coupled to the base;
a second clamp positioned parallel to and spaced apart from the first clamp;
a structure coupling the base to the second clamp, the structure defining a first side and a second side positioned at an orthogonal angle relative to the first side; and
a swivel connection assembly coupling a third integration assembly to the base, the swivel connection assembly comprising a female side defining a keyed opening and a male side including a male coupling plate configured to be inserted through the keyed opening and rotated to enable pivoting between multiple locked positions.

19. The assembly of claim 18, wherein the swivel connection assembly includes spring-loaded detents configured to provide tactile feedback in each locked position.

20. An ice fishing electronics integration assembly for use with a transducer mounting rod, the assembly comprising:
a base including electronic components comprising a display unit, a control interface, a power source, and a data processing unit configured to interpret sonar signals;
a first clamp operably coupled to the base; and
a second clamp positioned parallel to and spaced apart from the first clamp, the second clamp operably coupled to a structure spaced above the base.

21.-51. (canceled)
